(19) United States
(12) Patent Application Publication
(10) Pub. No.: US 2012/0303469 A1
(43) Pub. Date: Nov. 29, 2012

(54) SYSTEM AND METHOD FOR CONTENT MANAGEMENT AND DISTRIBUTION

(75) Inventors: David K. Robb, Charlotte, NC (US); Richard Robb, Boca Grande, FL (US); Joseph Rodriguez, Seattle, WA (US); Cameron Patterson, Seattle, WA (US)

(73) Assignee: DIY MEDIA, INC., Seattle, WA (US)

(21) Appl. No.: 13/571,303

(22) Filed: Aug. 9, 2012

Related U.S. Application Data
(62) Division of application No. 12/750,139, filed on Mar. 30, 2010.

(51) Int. Cl. G06Q 30/02

(52) U.S. Cl. 705/14.73

(57) ABSTRACT

A system for management of multimedia content having a processor and memory configured to execute software instructions for implementing a content management component operative to upload the multimedia content and to create at least one compilation from the multimedia content, a market management component operative to assign market-specific data to the compilation, and a store builder resource component operative to generate one or more online stores for promotion of the compilation having the assigned market-specific data.

### CROSS-REFERENCE TO RELATED APPLICATION

This application is a divisional of U.S. application Ser. No. 12/750,139, filed Mar. 30, 2010, the entirety of which is incorporated by reference herein.

### FIELD

The present disclosure relates generally to the field of electronic commerce, and in particular but not exclusively, relates to a system and method for the management of information representing digital goods and physical goods, the distribution of multimedia content, and the consummation of transactions between content owners, distributors and consumers.

### BACKGROUND

Electronic commerce on the Internet has become commonplace. There are many merchants offering goods and services via web sites on the Internet, and there are an even greater number of consumers who purchase the goods and services. In many cases, the electronic commerce transactions involve electronic content and physical goods. For example, many consumers purchase items such as books, compact disks (CDs) and digital video disks (DVDs) via the Internet. Consumers can also purchase electronic content such as information products, music or gain access to web sites that provide news or entertainment stories.

More significantly, many content owners often find it difficult or intimidating or are completely unable to establish viable ways to pursue electronic commerce directly with consumers. As a result, many of these content owners often find that they must comply with the restrictive terms and conditions imposed upon them by major online store owners such as iTunes, Amazon, Napster and others if they hope to have any meaningful ability to reach consumers directly. These types of online stores are well aware of the significant leverage they have over content owners, particularly content owners who have small business operations or who are independent visual and performing artists.

Moreover, very few online stores are able or willing to allow content owners to exercise direct control over the amount and type of content or channels of distribution for their content beyond those which are pre-approved by these stores. Indeed, few of these online stores enable content owners to specify combinations or packages of content to be bundled and sold as compilations or to control the specific manner in which such content or various compilations of content are marketed and sold. Furthermore, very few online stores will accept unilateral or more favorable access control restrictions imposed by content owners which might affect the ability of the online store owners to market and sell content.

Thus, there is a significant and rapidly growing need for a content management system that will empower content owners by enabling them to engage in electronic commerce directly with consumers with unfettered contractual restrictions on the types and combinations of content which can be produced and marketed. There is also a growing need by many content owners to exercise direct control over the pricing and territories in which their content is marketed and distributed, and to set varying levels of controlled access to such content for hired agents and representatives. Moreover, there is a genuine need for a solution that will enable content owners to market more effectively to prospective consumers and to pursue electronic commerce with them over the Internet as well as over the rapidly growing number of mobile networks and associated mobile devices.

### BRIEF DESCRIPTION OF THE DRAWINGS

Non-limiting and non-exhaustive embodiments are described with reference to the following figures, wherein like reference numerals refer to like parts throughout the various views unless otherwise specified.

FIG. 1 is a block diagram illustrating an operating environment for a content management system in an embodiment.

FIG. 2 is a block diagram illustrating an alternative operating environment for a content management system in an embodiment.

FIG. 3 is a block diagram illustrating the components of an application server for operation of a content management system in an embodiment.

FIG. 4 is a block diagram illustrating the operation of a content management system with a web server, a database server and a file transfer protocol server in an embodiment.

FIG. 5 is a block diagram illustrating the components of a content management system in an embodiment.

FIG. 6 is a block diagram illustrating a content management component in an embodiment.

FIG. 7 is a block diagram illustrating a market management component in an embodiment.

FIG. 8 is a block diagram illustrating a store builder resource component in an embodiment.

FIG. 9 is a block diagram illustrating a marketing resource component in an embodiment.

FIG. 10 is a block diagram illustrating an accounts tracking component in an embodiment.

FIG. 11 is a flow chart illustrating a method for content management in a content management system in an embodiment.

FIG. 12 is a flow chart illustrating a method for performing content conversion in a content management system in an embodiment.

FIG. 13 is a flow chart illustrating a method for confirming content conversion in a content management system in an embodiment.

FIG. 14 is a display diagram illustrating a user interface for a content management component of a content management system in an embodiment.

FIG. 15A is a flow chart illustrating a method for uploading and creating content compilations in a content management system in an embodiment.

FIG. 15B is a flow chart illustrating a method for requesting and updating a content inventory of a content management system in an embodiment.

FIG. 16A is a flow chart illustrating a method for uploading from a client device, storing content in a cloud-based storage service, and registering content in a content management system in an embodiment.

FIG. 16B is a flow chart illustrating a method for uploading content from a client device, storing content in a cloud-based storage service and registering content in a content management system in an embodiment.

FIG. 16C is a flow chart illustrating a method for uploading content from a client device, storing content in a cloud-based storage service, and registering content in a content management system in an embodiment.

FIG. 17 is a flow chart illustrating a method for uploading content from a distributor to a content management system for creation of content compilations in an embodiment.

FIG. 18 is a display diagram illustrating a user interface for a market management component of a content management system in an embodiment.

FIG. 19 is a flow chart illustrating a method for assigning market-specific data to content in a content management system in an embodiment.

FIG. 20 is a display diagram illustrating a user interface for a store builder resource component of a content management system in an embodiment.

FIG. 21 is a flow chart illustrating a method for generating a single song widget from use of the store builder resource component of a content management system in an embodiment.

FIG. 22 is a flow chart illustrating a method for generating an album widget from use of the store builder resource component of a content management system in an embodiment.

FIG. 23 is a flow chart illustrating a method for generating a full catalog widget from use of the store builder resource component of a content management system in an embodiment.

FIG. 24 is a flow chart illustrating a method for generating a buy button from use of the store builder resource component of a content management system in an embodiment.

FIG. 25 is a flow chart illustrating a method for generating a content preview clip button from use of the store builder resource component of a content management system in an embodiment.

FIG. 26A is a flow chart illustrating a method for performing a checkout operation using a widget, buy button, preview clip or link created from use of a store builder resource component of a content management system in an embodiment.

FIG. 26B is a flow chart illustrating a method for performing a checkout operation using a widget, buy button, preview clip or link created from use of a store builder resource component of a content management system in an embodiment.

FIG. 27 is a display diagram illustrating a user interface for a marketing resource component of a content management system in an embodiment.

FIG. 28 is a flow chart illustrating a method for selecting marketing resources using a marketing resource component of a content management system in an embodiment.

FIG. 29 is a display diagram illustrating a user interface for an accounts tracking component of a content management system in an embodiment.

FIG. 30 is a flow chart illustrating a method for setting different levels of access control on content using an accounts tracking component of a content management system in an embodiment.

### DETAILED DESCRIPTION

In the description to follow, various aspects of embodiments will be described, and specific configurations will be set forth. These embodiments, however, may be practiced with only some or all aspects, and/or without some or these specific details. In other instances, well-known features are omitted or simplified in order not to obscure important aspects of the embodiments.

Various operations will be described as multiple discrete steps in turn, in a manner that is most helpful in understanding each disclosed embodiment; however, the order of description should not be construed as to imply that these operations are necessarily order dependent. In particular, these operations need not be performed in the order of presentation.

The description repeatedly uses the phrases “in one embodiment”, which ordinarily does not refer to the same embodiment, although it may. The terms “comprising”, “including”, “having”, and the like, as used in the present disclosure are synonymous.

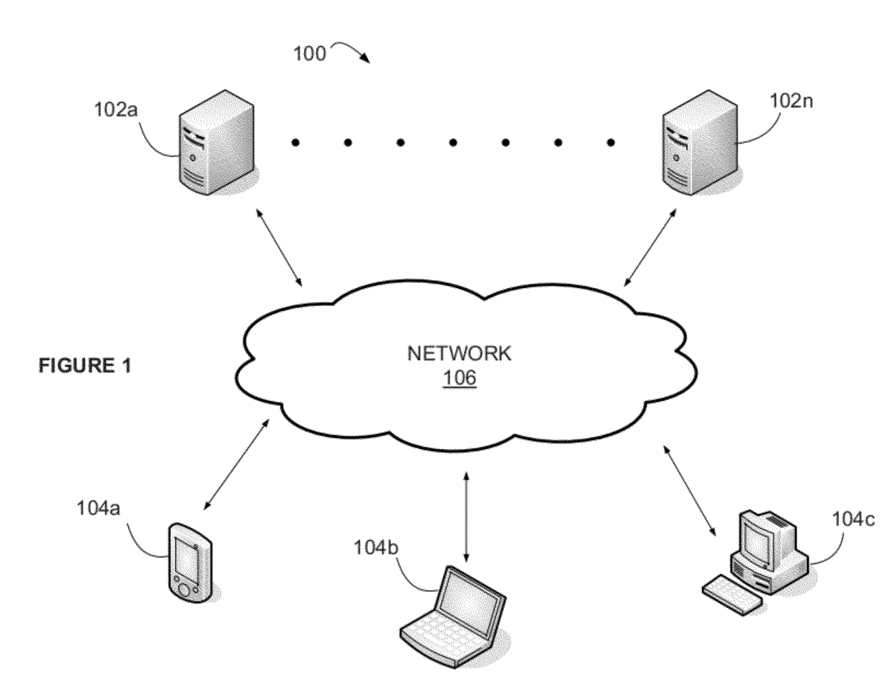

FIG. 1 is an illustration of an operating environment for execution of a content management system. In this embodiment, a user of a client device 104a, 104b, 104c is communicatively coupled to a network 106 which enables communication with one or more application servers 102a, 102n. In this embodiment, a user can be a content owner such as a musical artist, visual artist or other creator of creative works who uses a computer as a client device 104 or a mobile device such as a personal digital assistant (PDA), cell phone, a portable media player, a handheld game console, a digital camera, an e-book reader or other smart mobile technology to gain access to the content management system operating on one or more application servers 102a, 102n. The content management system is hosted and executed on one or more application servers 102a, 102n. In one embodiment, the network 106 is the Internet. In other embodiments, the network 106 can be a private computer communications network, a wireless communications network, or other computer data communications network enabling communications between computer devices and mobile devices.

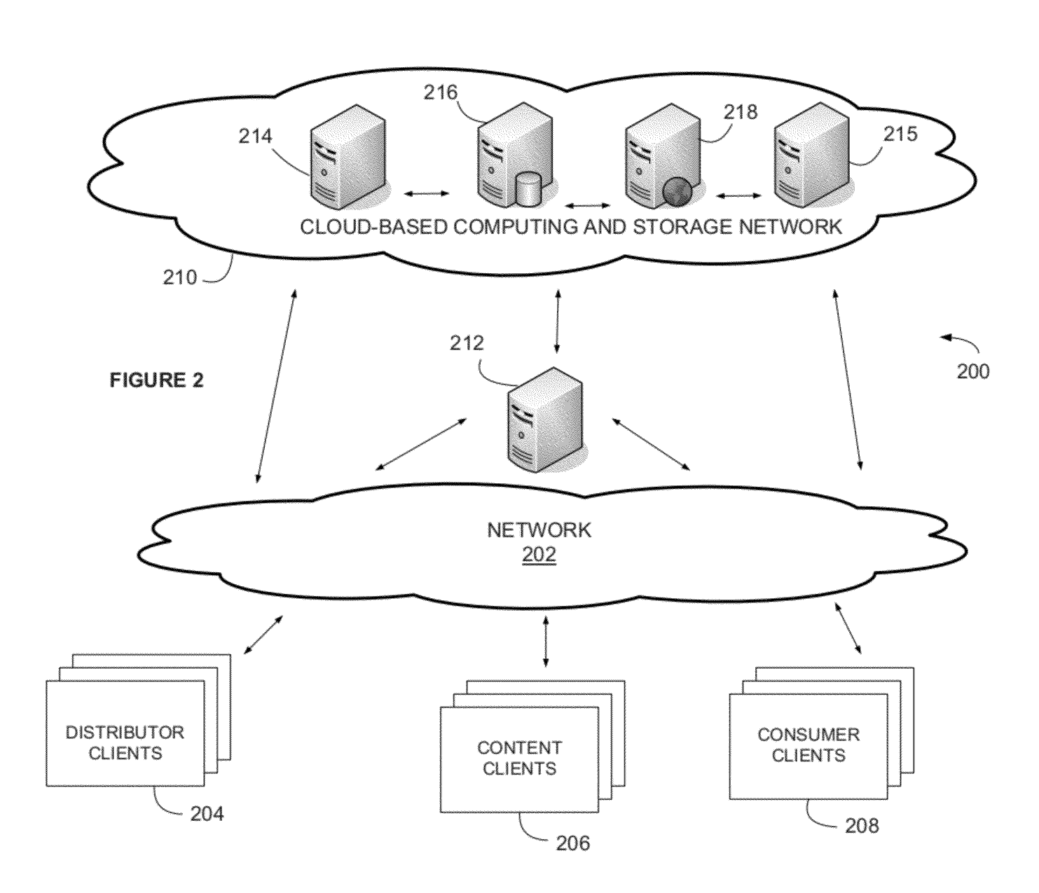

FIG. 2 is an illustration of an alternative embodiment for operation of a content management system. In this operating environment 200, one or more distributor client devices 204, one or more content owner client devices 206, and one or more consumer client devices 208 are illustrated. Each of these client devices is communicatively coupled to a network 202 which provides computing and communications access to an application server 212, a centralized compute processing and storage resource. In an embodiment, the network 202 is the Internet. In other embodiments, the network 202 can be a private computer communications network, a wireless communications network, or other computer data communications network enabling communications between computer devices and mobile devices. The application server 212 is communicatively coupled to a cloud-based computing and storage network 210. In one embodiment, content owners using content client devices 206 upload, register, manage, price, package and create one or more compilations of stored and registered content for distribution to one or more consumer client devices 208 using a content management system which is hosted and executed on the application server 212. The distributor client devices 204 are used by content distributors to provide distribution feeds of content which has been requested by content owners for inclusion in their content management systems. In one embodiment, the content delivered in these distribution feeds is uploaded and stored on data storage resources on a cloud-based computing and storage network 210, converted to one or more alternative file formats, and registered with the content management system resident on the application server 212. Once uploaded and registered with content management systems, the content included in such distribution feeds is available to be accessed and used by content owners for the creation of one or more compilations.

The cloud-based computing and storage network 210 is comprised of multiple web-based services which enable flexible and efficient operation of a content management system for a significant number of content owners and distributors. In one embodiment, the cloud-based computing and storage network provides one or more compute processing servers 214, one or more payment processing web servers 218, one or more database servers 216 and one or more message passing servers 215. In an embodiment, all resources used in the cloud-based computing and storage network 210 are provided by the Amazon Web Services group at Amazon.com, Inc. More specifically, in an embodiment the compute processing servers 214 are implemented using Amazon's “Elastic Compute Cloud” (EC2) resources. The EC2 is a web service that provides resizable compute capacity in a cloud-based network that can scaled to provide computing capacity for applications serving multiple client devices. The computing resources of the EC2 are used to perform to format conversions for digital content upon request from the content management system. In the same embodiment, the payment processing servers 218 are implemented using Amazon's “Flexible Payments Service” (FPS) to facilitate the payment processing and checkout process. The FPS can be used to process payments from consumers to charge to credit cards, debit cards or bank accounts who seek to gain access to digital content that is registered in a content management system. In this same embodiment, the database servers 216 are implemented using Amazon's “Simple Storage Service” (S3) which provides a data storage capacity be used to store and retrieve any amount of data, at any time, from anywhere on the World Wide Web. Likewise, in the same embodiment, the message passing servers 215 are implemented using Amazon's “Simple Queue Service” (SQS) which provides a hosted queue for storing messages as they are passed between different computers or distributed components of software systems. In this embodiment, the SQS is used to pass messages between executing processes on the application server 212 and the compute processing servers 214.

In an embodiment, content owners use client devices 206 to upload content for storage in the database servers 216 for registration in the content inventories of each content owner's content management system residing on an application server 212. In this embodiment, content owners gain access to storage and computing resources in the cloud-based computing services network 210 to store multimedia content. After storage in one more database servers 216, the application server 212 posts a “Conversion Request” message in the queue hosted on the message passing servers 215 which requests conversion services for the content which has been uploaded and stored in the database servers 216. This message specifies the present request for services, the target format for conversion of the received content and the location for storage of the originally uploaded master file and the location for storage of the format-converted file. The compute processing servers 214 respond to the conversion request message and perform a format conversion on the uploaded multimedia content files. The format conversion process is a trans-coding process which converts the file formats of the multimedia content to different format. The original uploaded files provided as the multimedia content are used as lossless master files to produce one or more trans-coded files with the different file formats. Once the conversion process is completed, the compute processing servers 214 store the converted files on the database servers 216, return the original master files to their storage location on the database servers 216, and post a “Conversion Complete” message in the queue hosted on the message passing servers 215.

In yet another embodiment, the distributor client devices 204 provide distribution feeds in response to content requests received from content owners. The content delivered in these feeds is provided in bulk and is parsed to ensure that each content owner receives the content desired for inclusion in their respective content management systems. Each distribution feed is parsed and the content allocated to each content owner as specified in the distribution feed. The newly received content for each content owner is stored on the database servers 216, registered in each respective content owners content management system and, when appropriate, the file formats of such content is converted using the compute processing servers 214. The status of these content conversion services is reported in messages sent to message queues hosted on the message passing servers 215. In this manner, the content management systems of multiple content owners can be routinely updated from distribution feeds received from content distributors using their client devices 204.

Consumers using the browsers on their client devices 208 can purchase one or more content files from directly from content owners by selecting content of interest in the online stores operated by content owners. After making their selections, consumers are redirected to the payment processing servers 218 used by these online stores to provide credit card or other information to complete purchase transactions. The payment processing servers 218 provide the checkout pages required for capturing payment information and processing payments and also provide direct access to content files stored on the database servers 216 for download to the client devices 208 used by consumers.

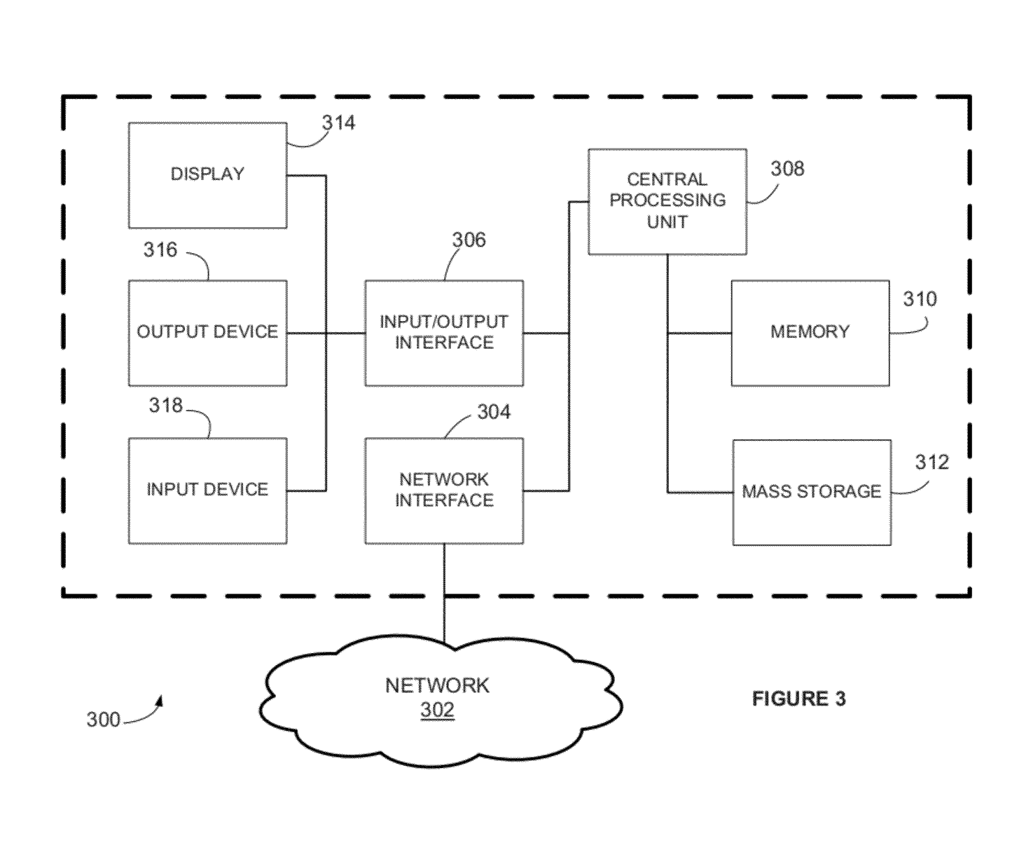

FIG. 3 illustrates an embodiment of an application server 300. In this embodiment, an application server 300 is coupled to a network 302 for receipt of data over a network interface 304 which will be processed in the central processing unit 308. Input/Output interface 306 is also coupled to the central processing unit 308 and used for receipt of information received on a display 314 and an input device 318. Input/Output interface 306 is also used for the output of information on the output device 316 as well as the display 314. In an embodiment, display 314 displays information on the status of file conversion processes or file storage services for monitoring by content managers or internal technical support service departments. Central processing unit 308 is coupled to a memory 310 and a mass storage device 312 for storage of the content management system and its components as well as a web server, file transfer protocol server and a database server, each of which are also executed by the central processing unit 308.

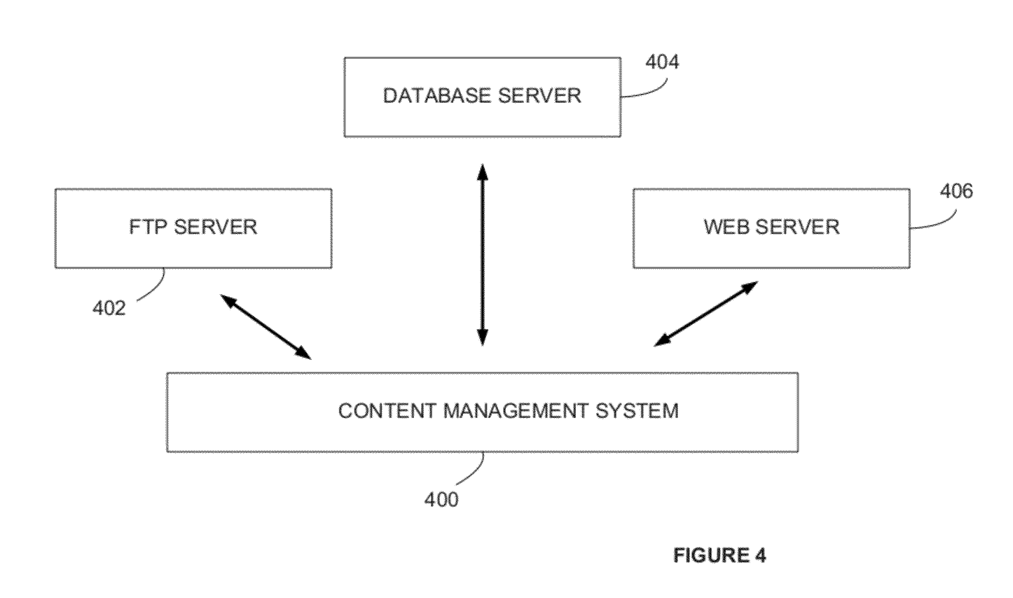

FIG. 4 illustrates several of the software processes which are executed on the application server 300 in an embodiment. The content management system 400 shown in this embodiment is communicatively coupled to a file transfer protocol server 402, a database server 404 and a web server 406. Each of these systems are hosted and executed on the application server 300 for use in the operating environments 100, 200. The web server 406 delivers web pages associated with online stores which are generated and owned by content owners and are used to enable potential consumers of content to review and download content files of interest. The database server 404 hosts the data and code needed for operation of the content management system 400. The file transfer protocol server 402 provides download and file transfer services to enable the transfer of content from cloud-based storage services, from distribution feeds, or for the upload of content from content owners and distributors. In these embodiments, content distributors have business relationship with the content owners that enable these content owners to place access requests for and use of distribution feeds provided from a content distributor's client devices 204. The database server 404 is used to register the content owner's uploaded content and to register the availability of distributor provided content on the cloud-based computing and services network

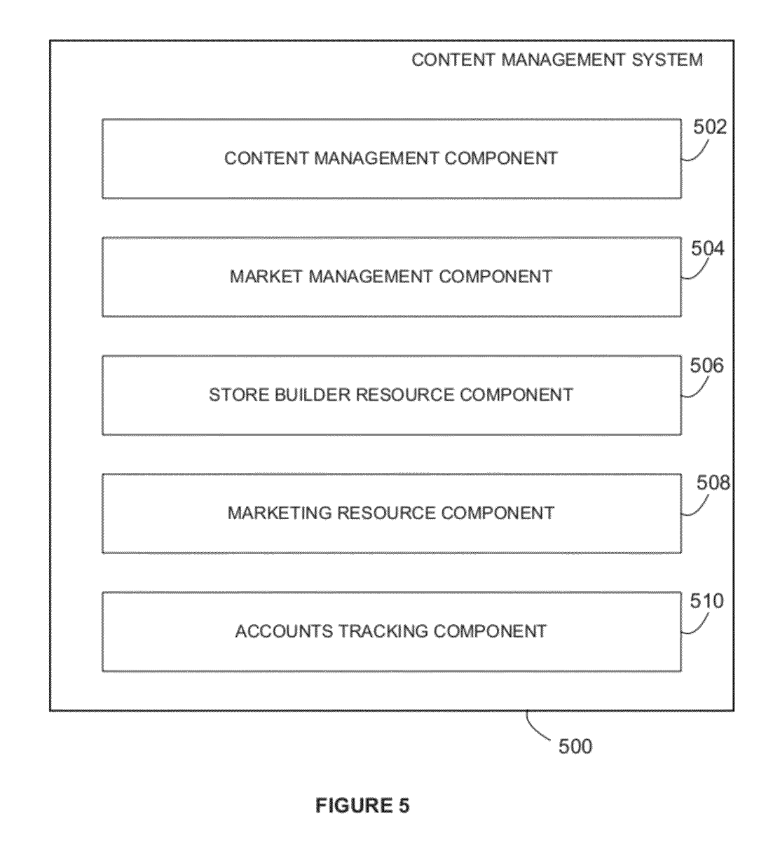

FIG. 5 is an illustration of the various components comprising a content management system 500 in an embodiment. In this embodiment, content management system 500 includes a content management component 502, a market management component 504, a store builder resource component 506, a marketing resource component 508 and an accounts tracking component 510. Each of these components is communicatively coupled to each other for the purposes of managing transactions related to the content owned by content owners. Content management component 502 provides support for the uploading of various types of files comprising multimedia content including but not limited to digital audio files, digital image files, digital video files, e-book files, digital audio-book files, computer-based video game files and other files and file types which may represent various types of physical goods. The content management component 502 also enables the receipt of distribution feeds from content distributors and can be used by content owners to create custom compilations based on the content uploaded by them or received from their distributors.

The market management component 504 is used by content owners to establish economic and business rules pertaining to pricing, territorial restrictions and timing of sales campaigns related to specific content files or content compilations. The store builder resource component 506 is used to generate online stores which are owned and operated by content owners. In an embodiment, such online stores are used to promote full catalogs of content, or subsets of content as chosen by content owners. The marketing resource component 508 provides access to custom resources for creating marketing campaigns that can be used by content owners to promote their content and compilations. The accounts tracking component 510 is used by content owners to track active and pending transactions, to enable payments, to create profiles and to establish access controls for use in limiting or controlling the scope of access by third party agents and representatives to the registered content in a content owner's content management system 500.

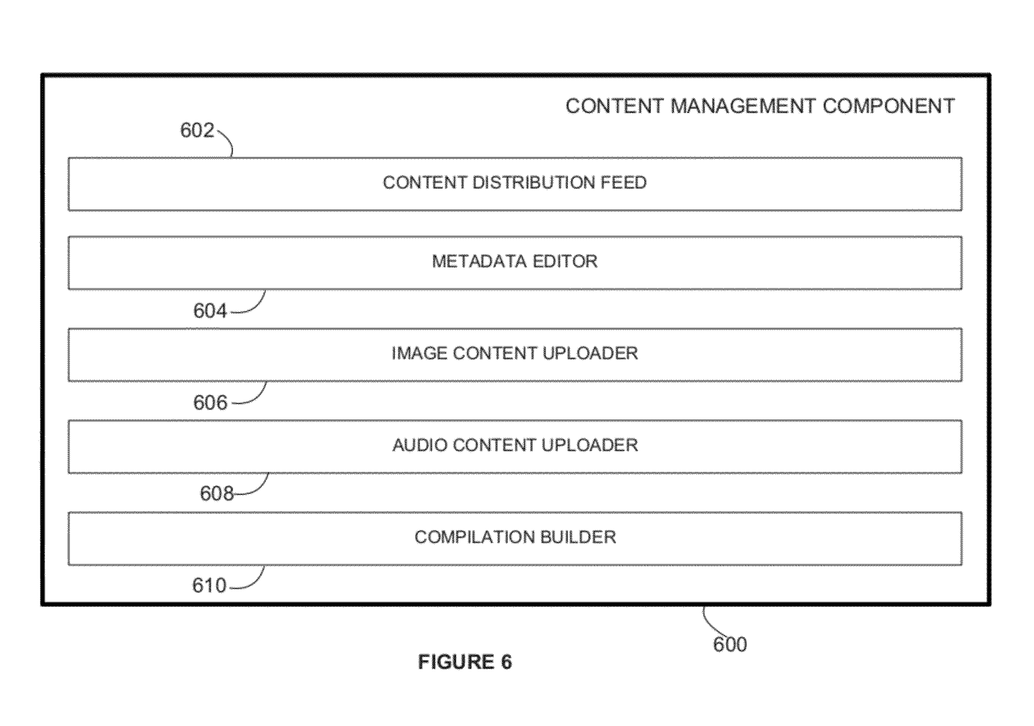

FIG. 6 illustrates an embodiment of a content management component. As is shown, content management component 600 is comprised of several services. The content distribution feed 602 is a service which enables content owners to request and receive distribution feeds from content distributors. The content provided by content distributors to content owners through such feeds is used to supplement and enhance the inventories of content provided by content owners in the content management system 500. The metadata editor 604 is a service that enables content owners to edit the metadata associated with content files. In one embodiment, the type of metadata that can be edited includes information pertaining to the musical content of a content owner. The type of metadata that is edited for musical content can include information such as title, artist name, release date, genres, catalogue number and Universal Product Code. Image Content Uploader 606 is a service which is specifically designed to upload, store and register image files provided by content owners for managed control in a content management system. In one embodiment the types of image files which can be uploaded using the Image Content Uploader 606 are GIF files, JPEG files and TIF files. Audio Content Uploader 608 is used for uploading audio files. In an embodiment the audio files types that can be uploaded using the Audio Content Uploader 608 include WAV files and MP3 files. Lastly, the compilation builder 610 is used by content owners to create custom compilations from the content available in the inventory managed by the content management system 500 that content owners seek to promote to consumers in one or more online stores.

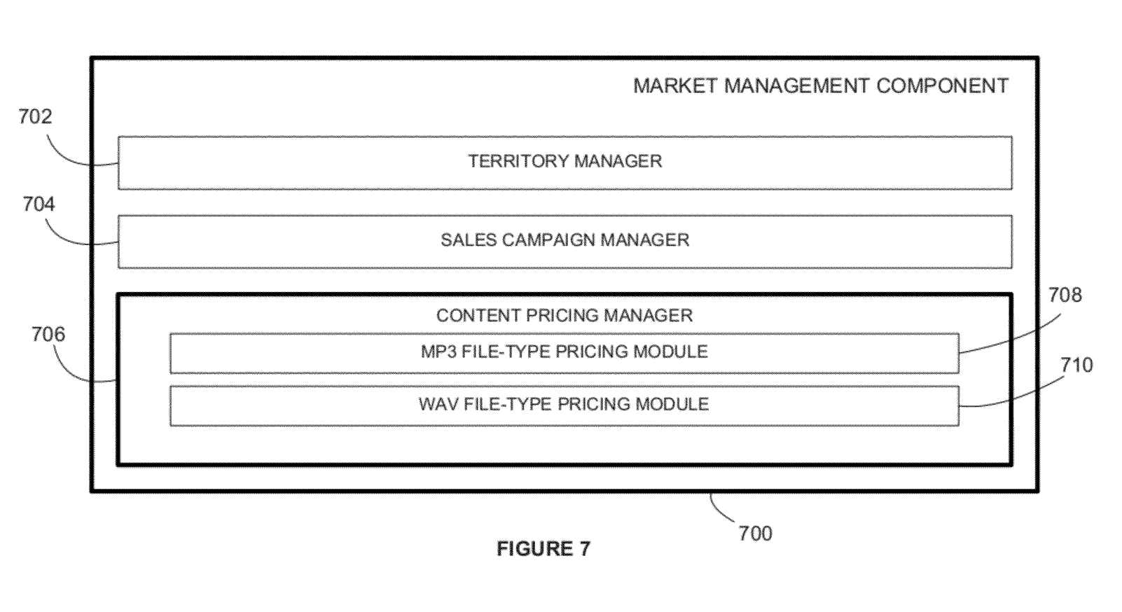

FIG. 7 illustrates the services provided in an embodiment of a market management component 700. As shown, one service is a territory manager 702 which is used by content owners to set the sales parameters and the timing of sales campaigns relating to specifically available content from a content owner in different geographic regions of the world. For example, a content owner may choose to provide a subset or only a particular release version of certain musical content for sales and marketing campaigns in Spain, Germany or France. While in other parts of the world, the content owner may choose to set different territorial restrictions on the availability of their content such as limiting the availability of musical content only to earlier releases rather than later releases in an entirely different part of the world, such as South America or in specific South American countries. The sales campaign manager 704 is another service provided in an embodiment of the market management component 700 that enables content owners to enable and disable sales campaigns by specified dates. The content pricing manager 706 is a service that allows content owners to set the pricing of particular files by file type. Although not limited only to musical content, in one embodiment the content pricing manager 706 is used to set pricing for MP3 file types, as shown by MP3 file type pricing module 708, and pricing for WAV files as set by the content owner using WAV file type pricing module 710. Although the present embodiment illustrates the use of musical content files such as MP3 files and WAV files for a content pricing manager 706, the use of a content pricing manager 706 is not limited only to the pricing of content for musical files, but can be applied to the pricing of content for image files, video files, audio book files, or video game files as well as many other forms of content generated by content owners.

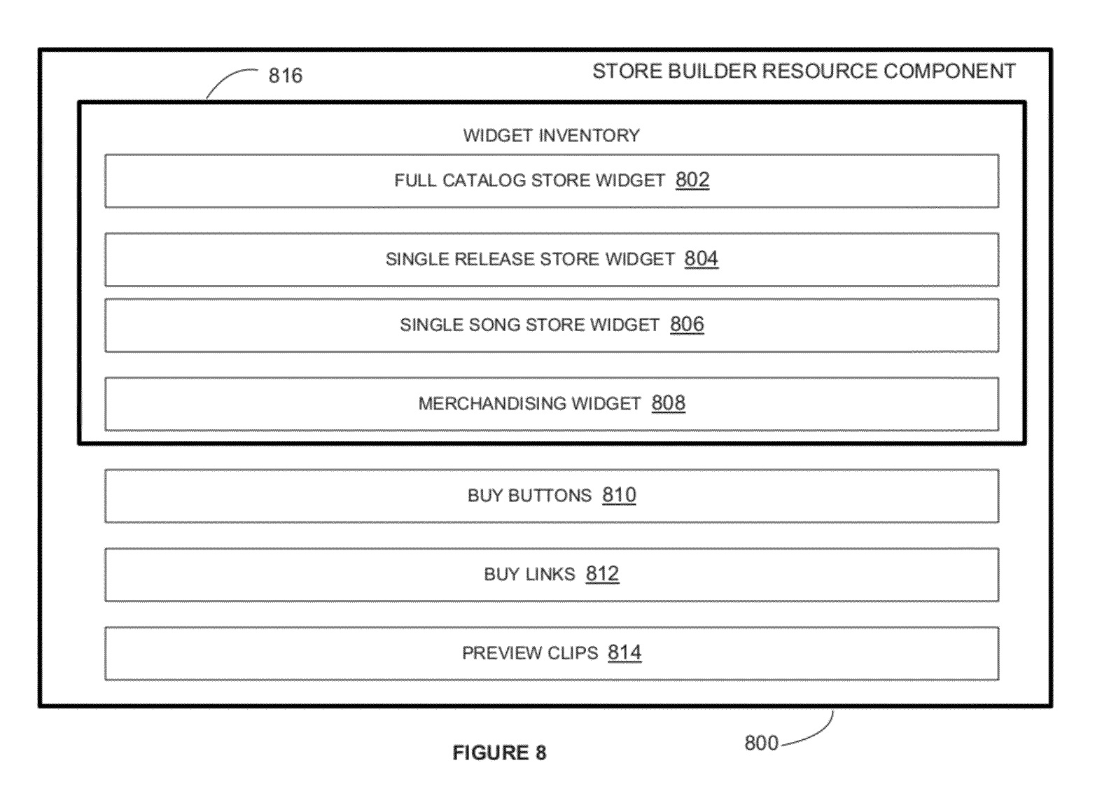

FIG. 8 depicts an embodiment of a store builder resource component. The store builder resource component 800 includes an inventory of “widgets” 816, buy buttons 810, buy links 812 and preview clips 814. In an embodiment, the widget inventory 816 includes services for managing full catalogs of digital music content, single releases of digital music content and single song digital music content. This store builder resource component 800 also includes a merchandising widget 808 for building stores that include marketing merchandise. In the present embodiment, the services pertain to musical content which is often complied in the form of “musical catalogs”, “musical releases,” and single songs. Full catalog store widget 802 is used for the creation and generation of an online store that will promote the full musical catalog of a content owner. Full catalog store widget 802 is used to generate, display and execute a flash movie or other video content that provides an overview of the content available in a content owner's online store. The widgets 802, 804, 806 can then be used to receive orders from consumers for the purchase or licensing of musical content in the specific groupings desired (i.e., catalog, release, or single song).

Single release store widget 804 is used to create a widget can be used to promote a single musical release in an online store in an embodiment. Single song store widget 806 is used to create a widget that promotes an online store with a single song provided by a content owner in an embodiment. Merchandising widget 808 is used to create a widget that is used to promote the merchandise or physical goods that a content owner may choose to promote alone or in association with one or more digital goods representing their musical content in an embodiment. Buy buttons 810 are generated by content owners using the store builder resource component 800 to create custom buttons that can be distributed to online resources on the Internet, on mobile communication networks or on other computer networks for use in promoting the online stores which are owned and operated by content owners. Buy links 812 can be used to generate hypertext transfer protocol (HTTP) links that can be widely distributed on the Internet, on mobile communications network or on other networks that enable consumers to click on such links to gain access to online stores which are owned and controlled by content owners where multimedia content, including various types of digital media files and physical good, can be downloaded. The preview clips 814 can be created using the store resource component 800 to generate video clips which execute in the browsers of consumer client devices 208 and enable those consumers to make informed choices about the types of multimedia content they may wish to download to their client devices 208.

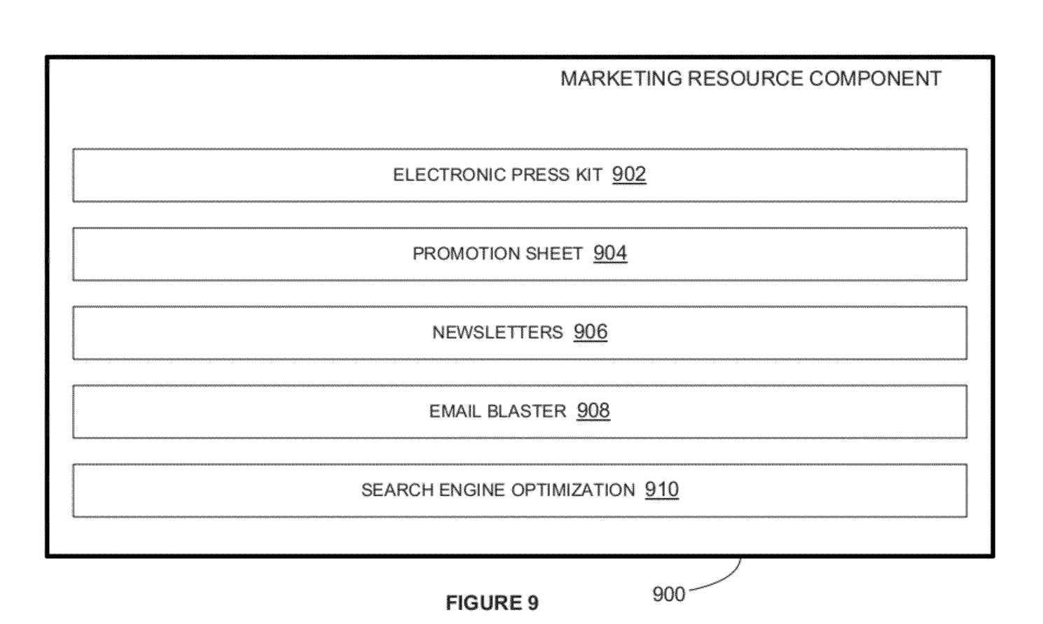

FIG. 9 illustrates an embodiment of a marketing resource component 900. In this embodiment, the marketing resource component 900 includes a service for creating electronic press kits 902, a service for creating promotion sheets 904, a service for creating custom newsletters 906, an e-mail blaster 908 service for creating and executing e-mail distribution campaigns and a specialized search engine optimization 910 service for use in optimizing the promotion of online stores generated by content owners. Marketing resource component 900 provides the full suite of resources to content owners to enable them to effectively promote and market their content on multiple web pages on the World Wide Web and over mobile communication networks users of mobile devices such as smart phones and PDAs.

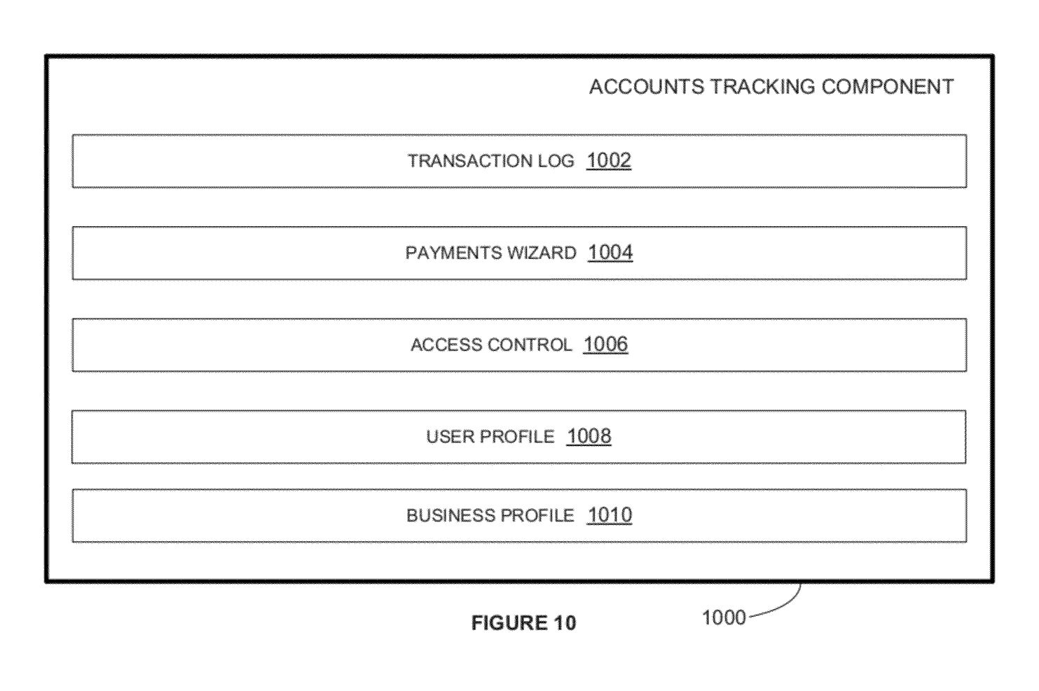

FIG. 10 illustrates an embodiment of an accounts tracking component. The accounts tracking component 1000 provides several services to enable content owners to manage their online stores. In one embodiment, the accounts tracking component 1000 provides a transaction log 1002, a payment wizard 1004, a service for setting access control restrictions on content files 1006, a user profile 1008 and a business profile 1010. Transaction log 1002 is used to track current and pending transactions and to provide information on sales revenues and earnings relating to the content promoted in a content owner's online stores. Payments wizard 1004 is used for capturing payment information from consumers and storing profiles of consumers who are frequent purchasers of content provided by content owners. The access control service 1006 enables content owners to selectively set restrictive access controls to enable content owners to directly manage the marketing, sales and distribution efforts of hired third party agents and representatives. In one embodiment, access control restrictions limiting the territorial scope of the efforts of sales teams or other partners and hired agents is provided. In another embodiment, access control restrictions are used to set a limit on the amount of time a sales team or sales person will have for the promotion of online content made available by a content owner. The user profile 1008 is used for the capture and storage of information relating to the content owner using the content management system. In one embodiment, the user profile 1008 includes the username, password, personal address and other identifying information associated with a content owner as a user of the content management system. Business profile 1010 enables content owners to operate multiple business accounts using a single login. In one embodiment, the business profile 1010 enables content owners to use a single user account but have it associated with an unlimited number of labels and sub-labels for the management of musical content. The business profile 1010 can also be used to manage an unlimited number of business identities that may promote entirely different content such as image content, video content, print publications and e-books.

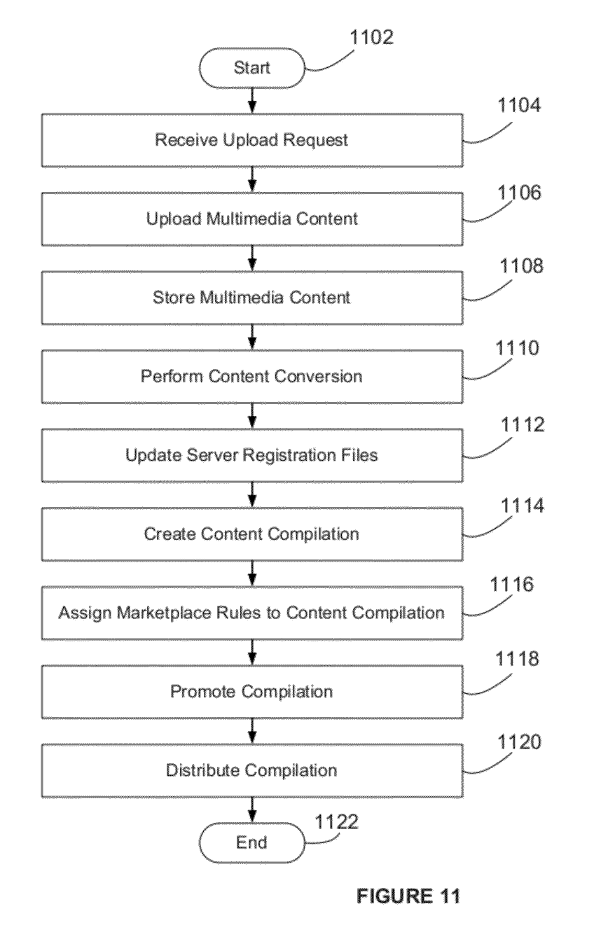

The FIG. 11 is an illustration of a method of operation of a content management system. This process starts at step 1102 and commences with the receipt of an upload request 1104 by the content management system. The content management system commences the upload of multimedia content at step1106, stores the multimedia content 1108, performs a content conversion 1110 process and updates registration files 1112 on an application server. Content owners can then create content compilations, as shown at step 1114, and assign marketplace rules to individual content files or to content compilations which they have created, as shown at step 1116. Content owners can use the content management system to promote their content compilations using marketing resources in the system, as shown at step 1118, and insure the successful distribution of content compilations as shown at step 1120. Use of the content management system in this manner enables content owners to maximize opportunities for their direct control over the organization, promotion and distribution of content and the execution of successful electronic commerce transactions with consumers using client devices on mobile networks as well as the Internet thereby achieving both electronic commerce and mobile commerce, referred to as “m-commerce.” In one embodiment, the storage of multimedia content at step 1108 is performed using one or more cloud-based storage services. The term “multimedia content” is used to characterize the range of content and file types that can be uploaded, stored, managed, promoted and distributed from the content management system and includes audio files, video files, video books, e-books, video games as well as electronic representations of physical goods such as merchandise associated with various forms of electronic goods that help in the promotion of content created by content owners.

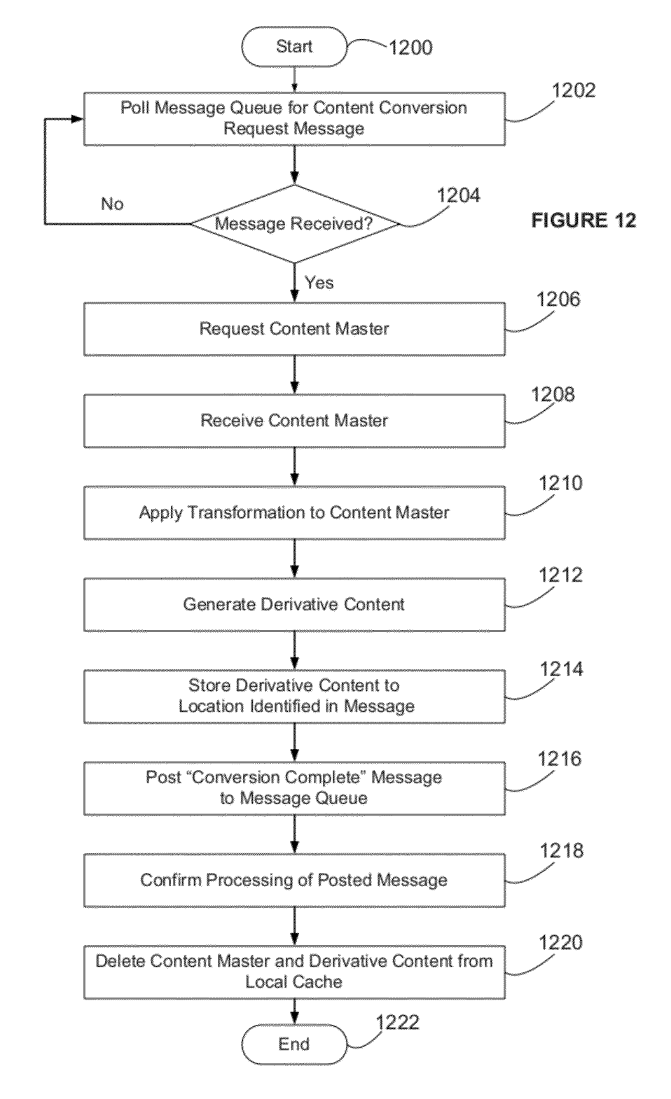

FIG. 12 is an illustration of a process in an embodiment for performing content conversions on uploaded content provided by content owners and content distributors. The process starts at step 1200 and commences with the polling of a message queue for “content conversion request” messages, as shown at step 1202. In this embodiment, cloud-based compute processing servers check a message queue of a cloud-based message queuing service. If a content conversion request message has been received, as shown at step 1204, a request is provided for a content master which is the lossless master file upon which transformations or derivative copies are to be created, as shown at step 1206. If no such content conversion message has been received or is unavailable in the message queue, the process returns as shown at step 1202 and a compute processing resource will continue to monitor a message queue for the receipt of a content conversion request message.

After requesting a content master, as shown at step 1206, the content master is received by a compute processing resource as shown at step 1208, and a content conversion or transformation is applied to the content master as shown at step 1210 and derivative content is generated from the content master as shown at step 1212. This derivative content is a format-converted version of the content master. The derivative content generated from the content master is stored in the location identified in the content conversion request message as shown at step 1214. Subsequently, the processor which performed the content conversion posts a “conversion complete” message to a message queue as shown at step 1216 and sends a message to the application server on which the content management system is executing to confirm the processing of the posted “content conversion request” message as shown at step 1218. The processor which performed the content conversion then deletes the content master and the derivative content file from its local cache, as shown at step 1220. In this manner, only one copy of the content master and one copy of the format-converted derivative content is stored in a web-based cloud storage service. The process ends as shown at step 1222 upon completion of the deletion of the content master and derivative content from the processor's local cache.

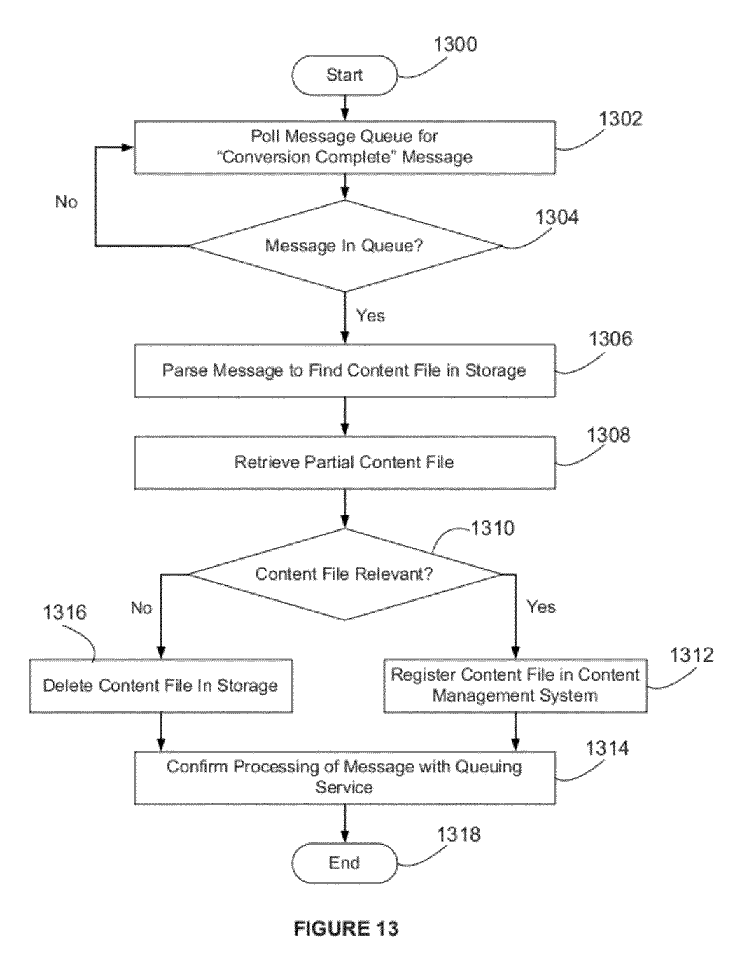

FIG. 13 illustrates an embodiment of a process for confirming the completion of content conversions. As shown, this process starts at step 1300, and begins with the polling of a message queue for “conversion complete” messages as shown at step 1302. If a conversion complete message is found in the queue, as shown at step 1304, the message is parsed to find the storage location of the content file in a web-based cloud storage service as shown at step 1306. If no conversion completed message is found in the queue, then the processor will enter a sleep mode for a defined period of time and then continue polling the message queue to find conversion complete messages. Continuing with the process after a conversion complete message has been found, once the content file is located in the web-based cloud storage service, a partial retrieval of the content file is performed, as shown at step 1308, to determine if the content is relevant. The determination of the relevance of a content file is performed by the application server which hosts and executes a content management system. A partial content file is determined to be relevant, as shown at step 1310, if no new masters have been uploaded since the creation of the file, if in the case of an embodiment involving musical content the particular musical track exists in the storage system, and the characteristics of the file meet the expectations of a converted or derived file (such as a derived MP3 file) then the content file is registered in the database on the application server which also ensures that a current, updated registration exists for the content in the content management system, as shown at step 1312. Afterwards, the application server will post a message to the message queuing service which confirms the processing of the conversion complete message, as shown at step 1314. Alternatively, if the content file is shown not to be relevant, as determined at step 1310, then the content file in storage will be deleted as shown at step 1316 and confirmation of the processing of a conversion complete message will be provided to the message queuing service, as shown at step 1314. Afterwards, this process completes as shown at step 1318.

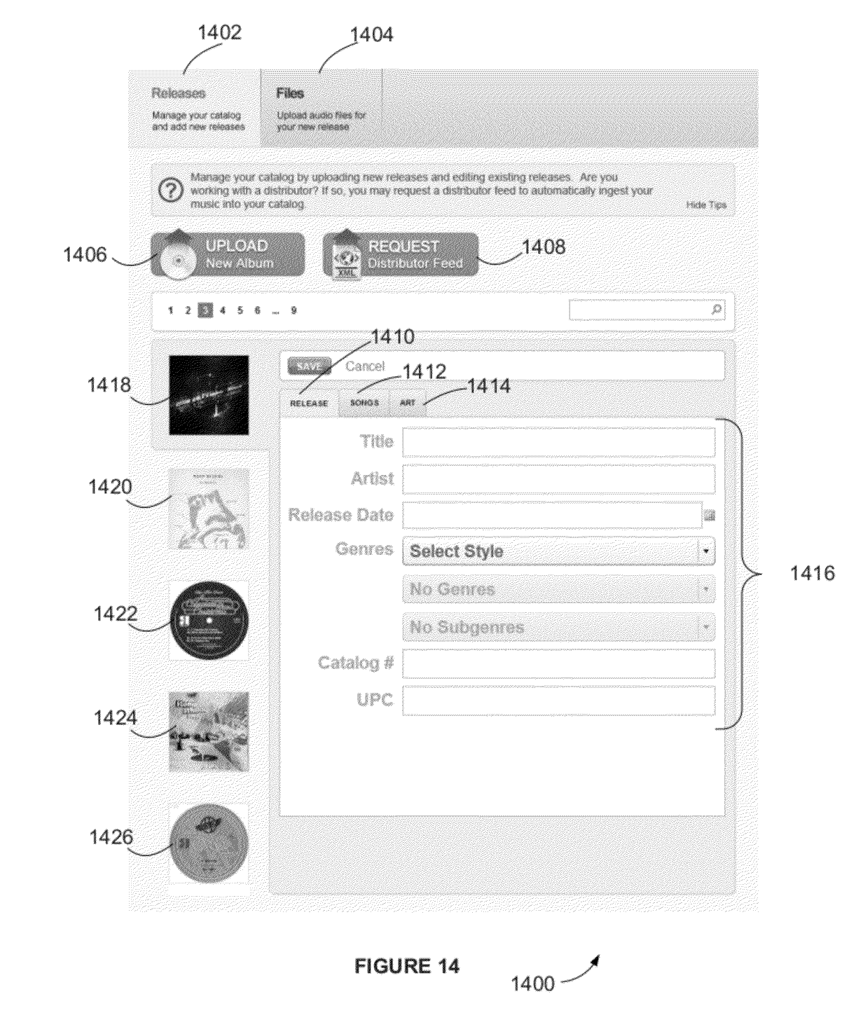

FIG. 14 is a display diagram illustrating a user interface for a content management component of a content management system. The user interface 1400 includes several elements. A content owner's current releases and associated content files are selectable from the release tab 1402 and the content files tab 1404 shown in this representation of a user interface 1400. A content upload button 1406 along with a button 1408 to enable a content owner to request a distributor feed are also provided. As shown in this representative embodiment, a content owner has multiple releases 1418, 1420, 1422, 1424 and 1426 each with its own release cover. In an embodiment, release tab 1410 is provided along with songs tab 1412 and art tab 1414 in an inner portion of the user interface 1400. In this embodiment, release tab 1410 includes multiple fields 1416 and include a field for a release title, a release artist name, a release date, genres field with a selectable hold down to identify a specific musical genre. A field for identifying one or more subgenres, a field for identifying the catalog number for a release, and a field for identifying the Universal Product Code (or UPC) for a release are also provided. Although the embodiment of user interface 1400 shown in this display diagram pertains to musical content, the present disclosure encompasses applications of user interfaces for the display of data and compilations of content of other types including videos, video games, audio books and e-books.

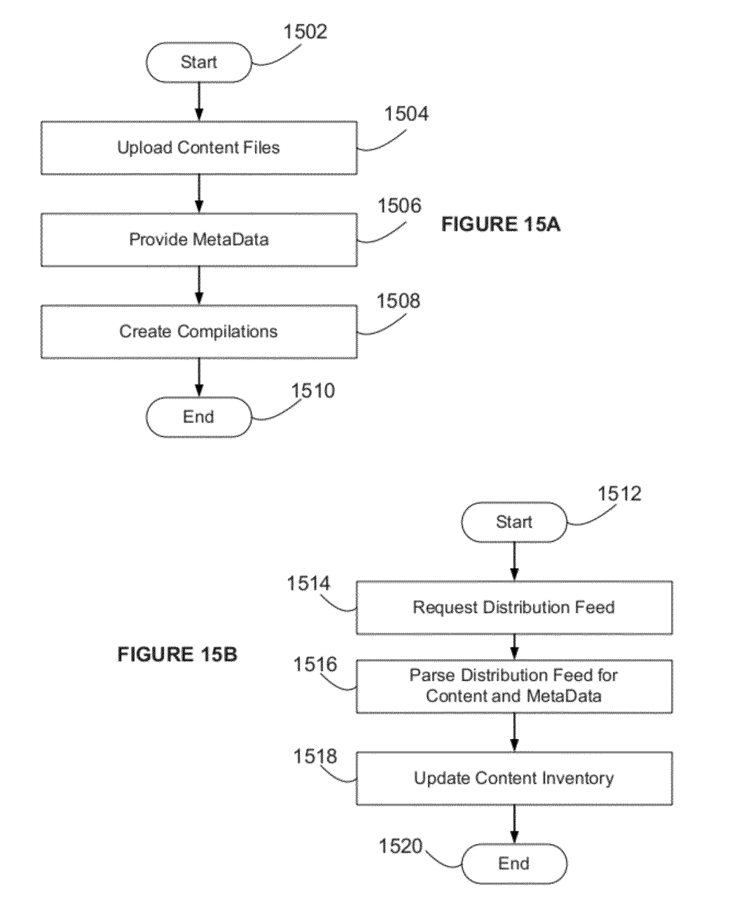

FIG. 15A is an illustration of a process followed by a content owner to upload content files and to create compilations from such content in a content management system in an embodiment. This process starts at 1502 and commences with the uploading of content files identified by a content owner, as shown at step 1504. The process continues with the content owner providing method data associated with the content files as shown at step 1506 and the creation of one or more compilations which are based on combinations or subsets of content files that will be promoted by the content owner as shows at step 1508. In an embodiment, a compilation is a single digital media file and its associated metadata. This process concludes as shown at step 1510 after each content file has been uploaded and marked with its associated metadata and organized into one or more compilations.

FIG. 15B depicts a process used by content owners to request distribution feeds for the updating and supplementing of their content inventories content management systems. This process starts at step 1512 and commences with the requesting of a distributor feed as shown at step 1514. Upon receipt of distribution feed, the feed will be parsed for content and related metadata as shown at step 1516 and then content inventory of the requesting content owner will be updated with the content and metadata received in the distribution feed, as shown at step 1518. After updating of the content inventory, this process completes as shown at step 1520.

In one embodiment, the parsing of a distribution feed is performed by a third party agent, which receives the distribution feed requested by a content owner. The distribution feed in this embodiment is a bulk aggregation of content for distribution to the content management systems of all content owners who have placed a request for a distribution feed. Thus, the distribution fee can include content from many or all of these different content owners and the third party would parse the distribution feed for content, identify which content is to be delivered to which content owner's content management system, and then ensure that all content owners using the content management system would have their respective content inventories updated with the contents and related metadata provided in the distribution feed from the content distributor.

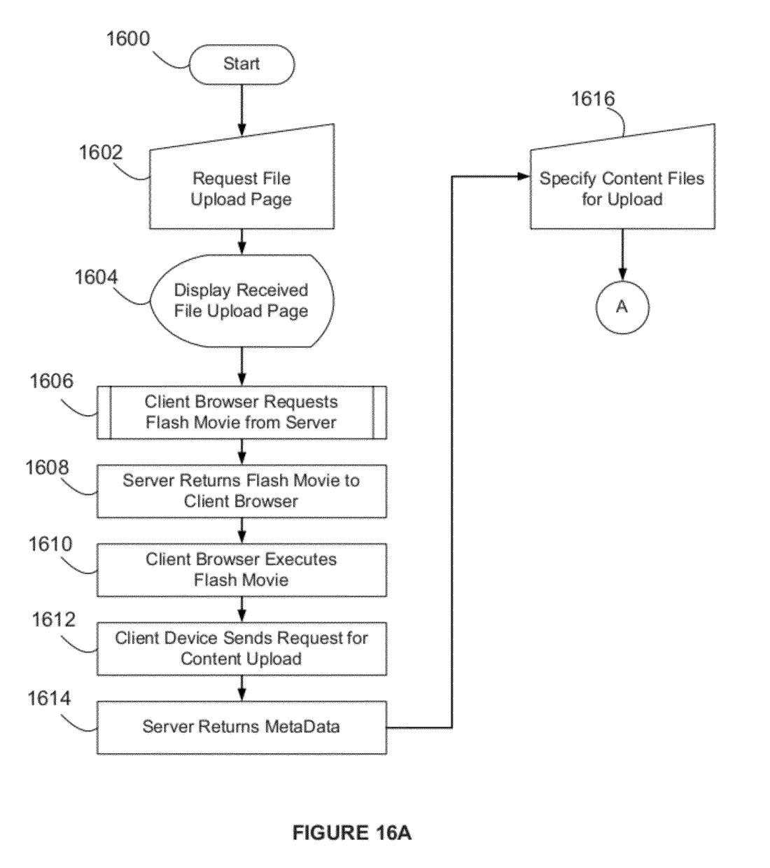

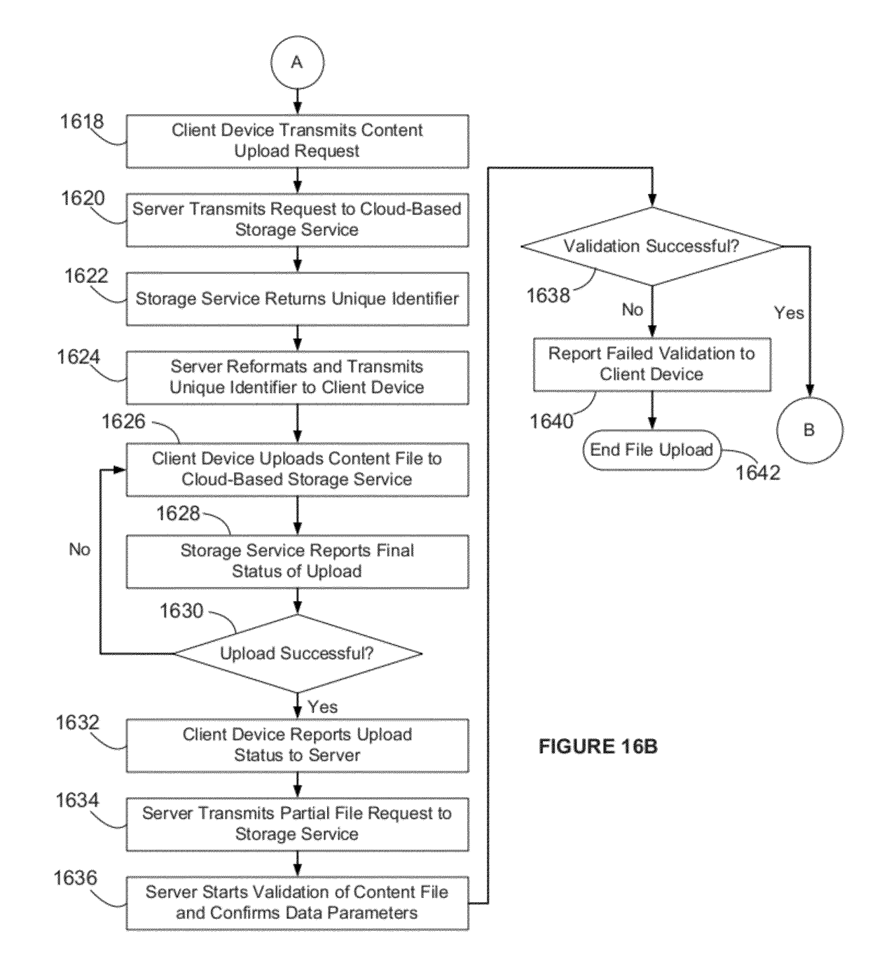

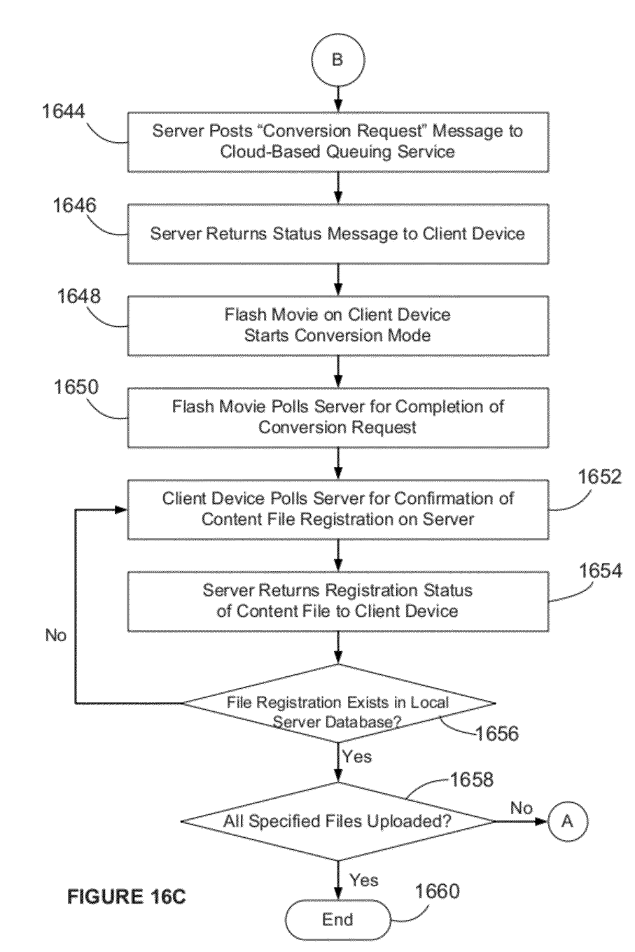

FIGS. 16A, 16B and 16C set forth in greater detail the steps in the process that enables content owners to upload, store, register and process content files in an embodiment of a content management system which works in conjunction with web-based cloud computing and storage resources. In this embodiment, a content owner seeks to upload additional content contributions to an existing content portfolio (e.g., one or more music content files to an existing portfolio of music content files stored on a web-based cloud storage resource which represent an album, collection or compilation release). As shown in FIG. 16A, this process starts at step 1600 and commences with a manual request by a content owner who requests a file upload page from an application server which hosts and executes a content management system, as shown at step 1602. The file upload page delivered by the application server is received and shown in a display, as shown at step 1604, and the process is executed by a browser running on a content owner's client device, which requests a flash movie from the application server on which the content management system is hosted and executed, as shown at step 1606. The application server returns a flash movie to the client browser, as shown at step 1608 and the client browser then executes the flash movie as shown at steps 1610. In an embodiment, the flash movie provides information to a content owner on how to upload and register content files in the content management system. After execution of the flash movie on a client browser, the client device on which the client browser is running sends a request for a content file upload, as shown at step 1612. In uploading content files to an existing portfolio of stored content, the application server provides metadata to the flash movie for review by the content owner. In the specific case of music content, the metadata includes information such as an album, release or compilation identifier, album title, album artist, label name, song index, song name, song artist name and identifiers of stored master files and format-converted files. Such metadata enables content owners to confirm the specific album, release or compilation with which the newly uploaded content files will be associated. The application server returns this metadata, as shown at step 1614, and the content owner proceeds by selecting the content files for upload, as shown at step 1616.

Referring now to FIG. 16B, the client device used by the content owner transmits a content upload request to the application server as shown, as step 1618. The application server transmits a request to a cloud-based storage service as shown at step 1620 and the storage service returns a unique identifier to the application server as shown at step 1622. The application server reformats and transmits the unique identifier to the client device used by the content owner as shown at step 1624 and the client device commences with the uploading of one or more content files to the cloud-based storage service as shown at step 1626. In one embodiment, the file type for the content selected for upload by a content owner determines the type of uploader used for that file. Specifically, in this embodiment, an image content uploader is used for the uploading of image files (i.e., GIF files, JPEG files and TIF files) and an audio content uploader is used for the uploading of audio files (i.e., WAV files and MP3 files). The cloud-based storage service reports the final status of the content upload, as shown at step 1628. Once the final status report is received, the client device determines whether the upload was successful, as shown at step 1630. If the upload was successful, the client device will report the upload status to the application server, as shown at step 1632. If the upload and storage in the cloud-based storage service was not successful, as shown at step 1632, then the client device will re-attempt the upload of the content file to the cloud-based storage service, as shown at step 1626. After the client device reports a successful upload to the application server, the application server transmits a partial file request to the cloud-based storage service, as shown at step 1634. Upon receipt of the partial file, the application server will apply a validation process using the content file to confirm its data parameters, as shown at step 1636. If the validation process is successful as shown at step 1638, the process continues with the application server posting a “conversion request message” to a cloud-based message queuing service, as shown at step 1644 in FIG. 16C. If the validation process is unsuccessful, then a status message will be sent to the client device which will report a failed validation, as shown at step 1640, and the upload process will end, as shown at step 1642.

FIG. 16C illustrates an embodiment of the upload process after the posting of a content conversion request message to a cloud-based message queuing service. After posting this message, the application server returns a status message to the client device, as shown at step 1646, and a flash movie will commence running in the browser of the client device. This flash movie will starts the conversion mode on the cloud-based computing and storage network, as shown at step 1648. The flash movie will poll the application server for completion of the conversion request, as shown at step 1650. As the content conversion process is performed, the client device will poll the application server for confirmation of content file registration, as shown at step 1652. In one embodiment, a content file will be registered in the database of the application server after completion of a content conversion process. If polled by the client device, the application server will return the registration status of the content file to the client device, as shown at step 1654, and the application server will also confirm whether a file registration exists in its local database, as shown at step 1656. If a file registration exists, then the application server will query the client device to determine if all specified files have been uploaded, as shown at step 1658. If all files have been uploaded, the upload process ends, as shown at step 1660. If no file registration exists in the local server database, as shown at step 1656, then the client device will continue to poll the application server for confirmation of registration of the content file on the application server, as shown at step 1652. At the time the application server confirms whether all specified files have been uploaded, as shown at step 1658, if more files are to be uploaded, the process returns to step 1618 (See FIG. 16B) where the client device will transmit a new content upload request specifying a different content file.

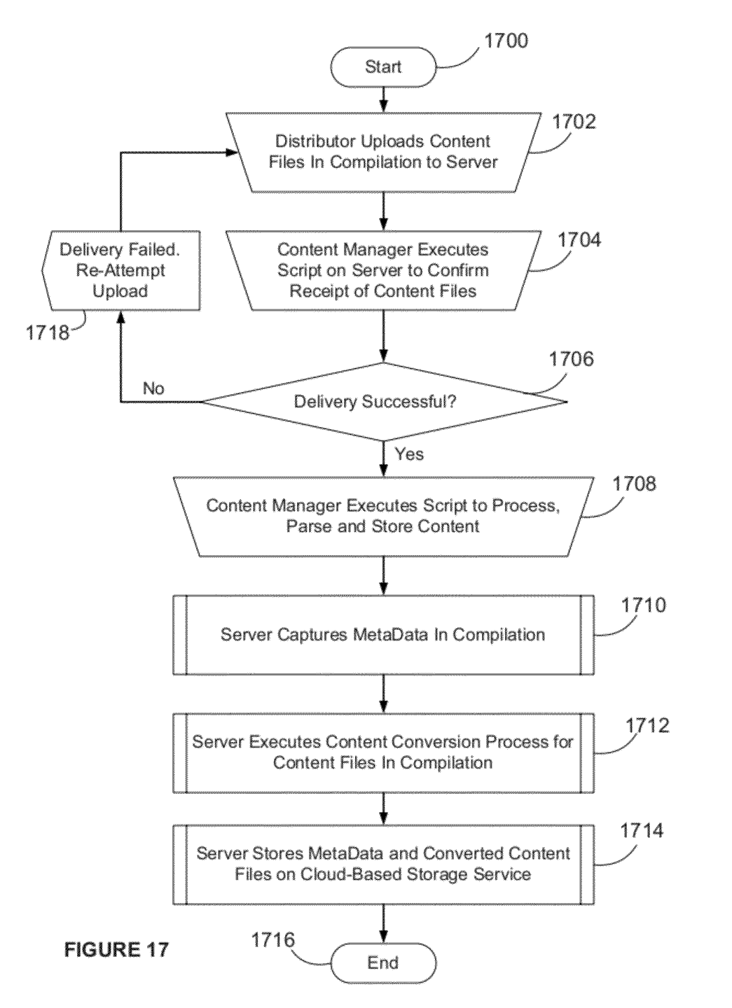

FIG. 17 is an illustration of the process used by a distributor for content uploading in one embodiment. This process starts at step 1700 and commences with a distributor uploading content files in a compilation to an application server, as shown at step 1702. A content manager working on behalf of a content owner will execute a software script on the application server to confirm whether the distributor's content files have been received, as shown at step 1704. If the delivery of content files was successful, as shown at step 1706, then the content manager will execute a different script to process, parse and store the content files, as shown at step 1708. If the delivery of the distributor's content files was unsuccessful, as shown at step 1706, then a message will be returned to the distributor's client device which will indicate that the delivery failed and that the distributor is to re-attempt the upload of the content files, as shown at step 1718. Returning to the point after the content manager executes a script to process, parse and store content files, as shown at step 1708, the application server will capture the metadata in the compilation, as shown at step 1710 and then the application server executes a content conversion process on the content files in the compilation, as shown at step 1712. Afterwards, the application server will store the metadata and converted content files on a cloud-based storage service, as shown at step 1676, and the process then terminates, as shown at step 1680.

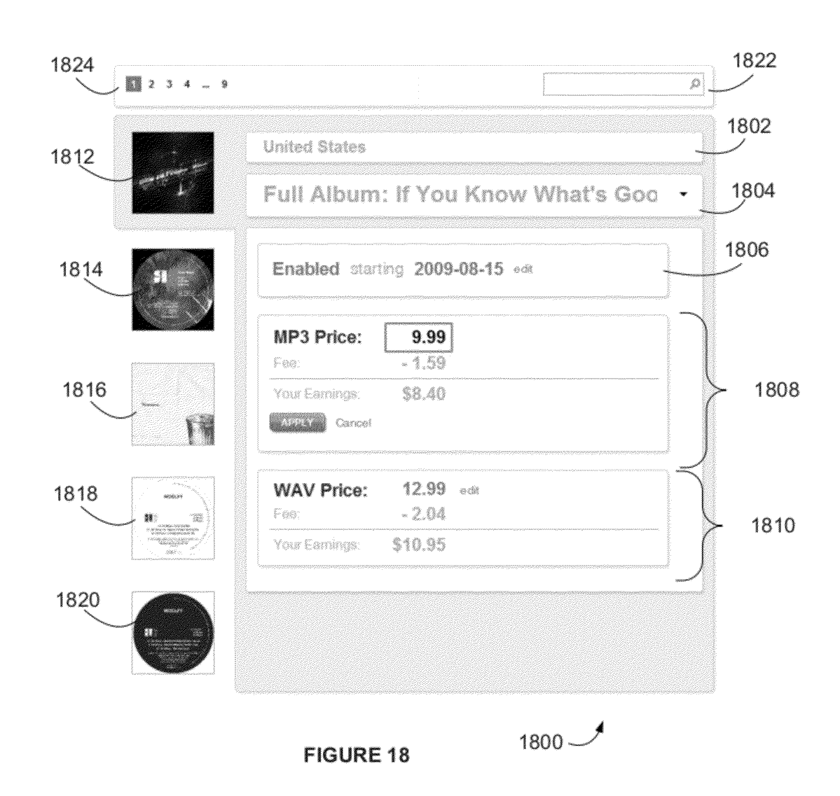

FIG. 18 is an illustration of a user interface for a market management component in a content management system. In this user interface 1800 several fields are provided to assist a content owner to price and market multimedia content. In the specific case of musical content, the user interface 1800 is used to assist a content owner to set pricing and territorial restrictions on an individual song basis, on a per-release or per-compilation basis and on a per-catalog basis. Field 1802 enables a content owner to specify the geographic territory or location for the promotion and sale of the content owner's multimedia content. Field 1804 enables the content owner to identify the specific content to which the specific price and territorial restrictions will be applied. In this example, the content owner has chosen the full album content with a title that begins “If You Know What's Going . . . ”. Field 1806 includes information identifying the date or dates when the sales campaign with the specifically set price and territorial restrictions is to be enabled. In this example, a starting date of Aug. 15, 2009 has been set by the content owner as the date on which the sale on the designated terms can begin. Field 1808 includes the MP3 pricing for an owner's content file. In the present example, the content owner has set a price of $9.99 as the MP3 price for the content when sold in the United States. Field 1810 allows a content owner to specify a price for the content file in a different format. In this embodiment, the content owner has also set a price for a WAV file for the music content identified in field 1804 in the geographic area identified in field 1802. In this example, the content owner has specified a WAV content file price of $12.99. The user interface 1800 also includes the covers for several widgets that are available to be used to promote the owner's content in online stores. These widgets are specified in fields 1812, 1814, 1816, 1818 and 1820. In addition to the page shown in the user interface 1800, additional pages can be selected for review for the purpose of setting price and territorial restrictions. These additional pages can be accessed by a content owner using the page selections in field 1824.

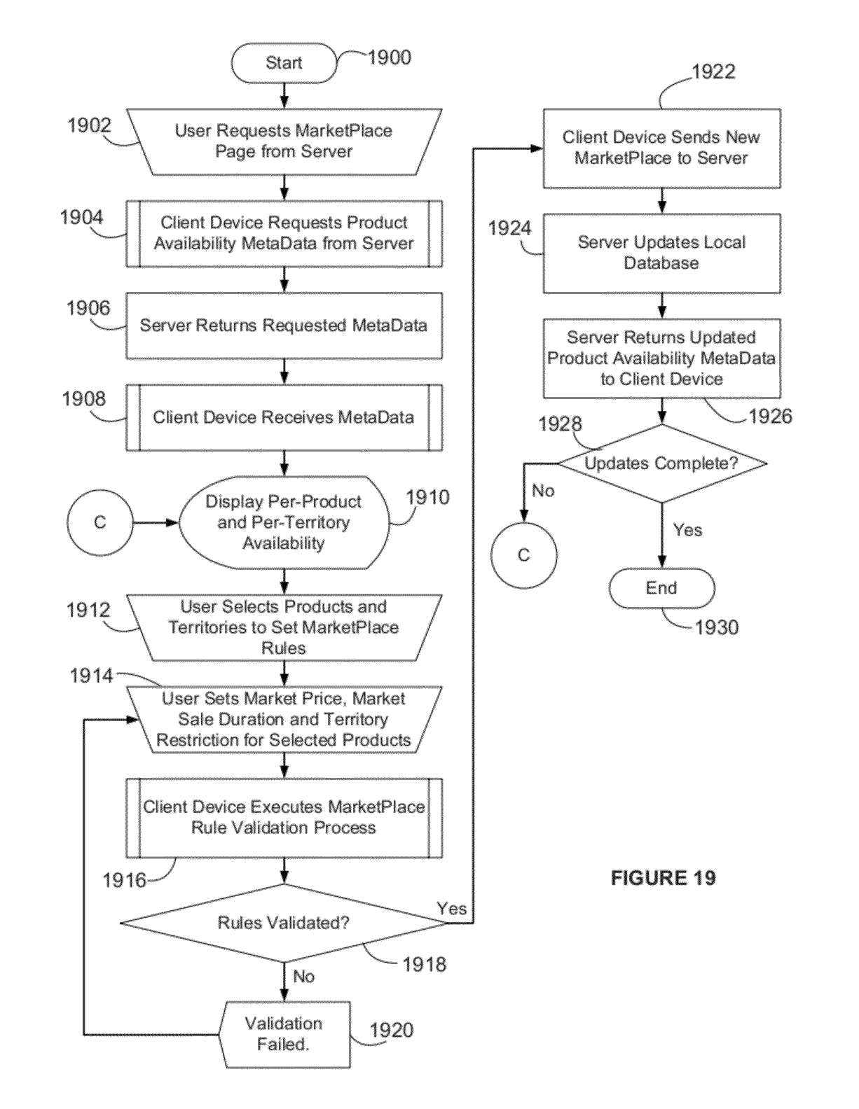

FIG. 19 depicts an embodiment of a process for using the market management component in a content management system. This process commences at step 1900 and begins with a user requesting a marketplace page from the application server, as shown at step 1902. The marketplace page is delivered from operation of the market management component in an embodiment. After receipt of the marketplace page, the client device used by a content owner requests product availability metadata from the application server using a predefined process as shown as step 1904 and the application server returns the requested data, as shown as step 1906. The client device then receives the metadata as shown at step 1908 and displays content which is available on a per-product and per-territory basis, as shown at step 1910. A content owner then selects products and territories to for which market place rules are to be established, as shown at step 1912. In addition, the content owner sets the market price, the market sale duration and territory restrictions for the selected products as shown at step 1914 in an embodiment. Once such parameters have been set, the client device executes a market place rule validation process, as shown at step 1916 to determine whether the market place rules can be validated, as shown at step 1918. If the validation process fails, a validation failure error is produced and displayed, as shown at step 1920 and the user must re-set the desired market price, market sale duration and territory restrictions for the selected products, as shown at step 1914. If the market place rules are validated, the client device will send new market place availability data to the application server, as shown at step 1922 and the application server will update its local database based on these new market place rules, as shown at step 1924. Afterwards, the application server will return updated product availability metadata to the client device as shown at step 1926 and query to confirm whether all updates have been completed, as shown at step 1928. If the updates have been completed, the process ends as shown at step 1930. If the process is not complete then per-product and per-territory availability data will be displayed once again on the client device, as shown at step 1910, and the process will recommence with the user selecting products and territories and setting market pricing, market sale duration and territory restrictions for a selected set of products. Content owners use the market management component to directly set market pricing and related market parameters for consumers who must then decide whether they wish to abide by or accept the terms set by the content owners.

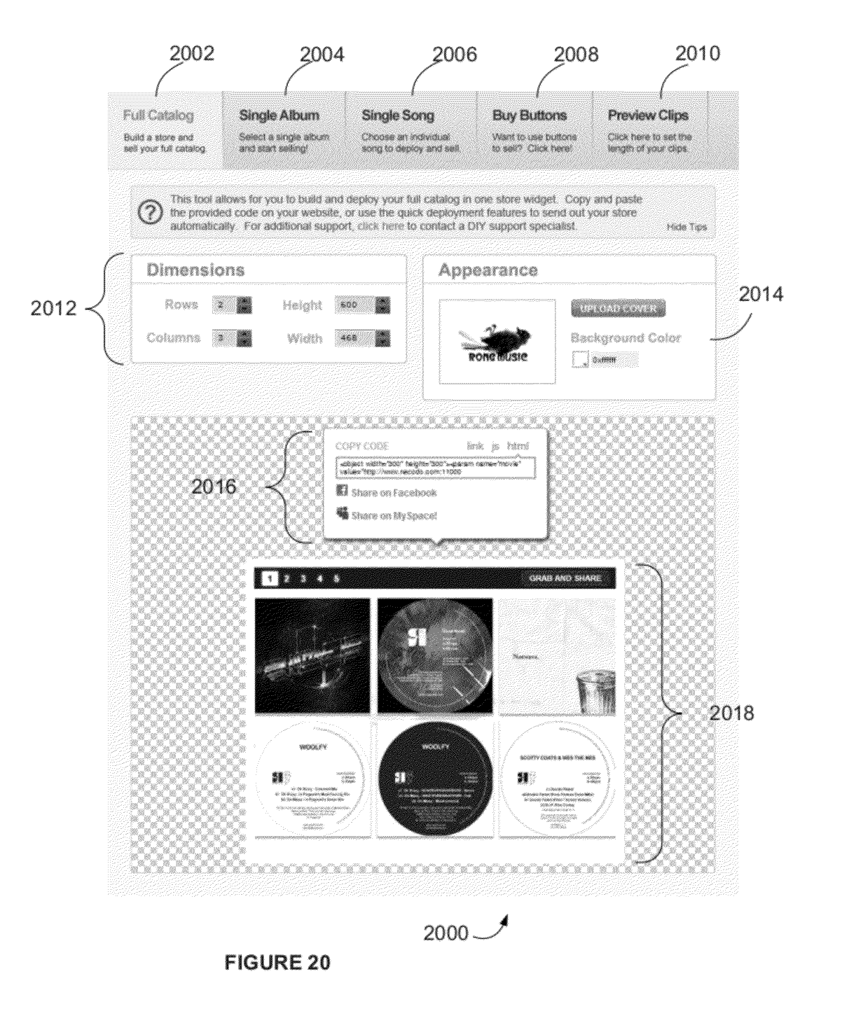

FIG. 20 illustrates a display diagram of a user interface for the store builder resource component of a content management system. User interface 2000 includes several components that will enable content owners to create widgets, buy buttons, links, and preview clips for various groupings of multimedia content. In one embodiment using music content, content files can be specified from a full catalog 2002, a single album 2004, or a single song 2006. In addition to widgets, buy buttons 2008 and preview clips 2010 can be used for the creation and promotion of online stores which are owned and operated by content owners. As shown in this diagram, a content owner has chosen to create a widget to promote its full catalog 2002. The dimensions of the widget can be selected using the parameters shown in field 2012, which indicates dimensions for rows, columns, height and width. A separate field 2014 allows the content owner to set the appearance of the widget, which would be akin to an album cover for use with an electronic widget. Once such data is specified, copy code is generated and displayed for use by the content owner in its marketing and distribution campaigns, as shown in field 2016. Illustrations of the widgets that can be used for the marketing of the content owner's full catalog are illustrated in field 2018, which includes representative illustrations of widgets that can be distributed over multiple networks including networks having mobile devices.

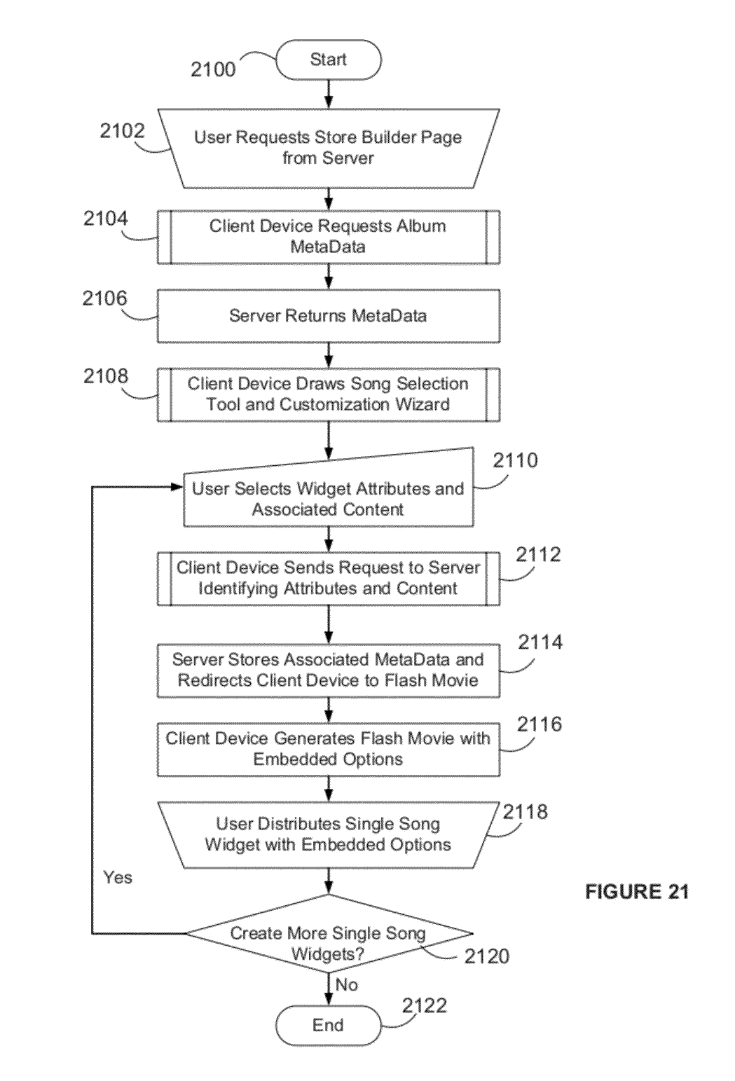

FIG. 21 is an illustration of a process for creating single song widgets using the store builder resource component of a content management system. This process starts at step 2100 and commences with a user who makes a request for a store builder page from an application server on which a content management system is hosted and executed, as shown at step 2102. A representative user of the store builder resource component in one embodiment is a content owner. The user's client device then performs a predefined process to request album metadata, as shown at step 2104 and the server returns the metadata, as shown at step 2106. Using this metadata, the client device draws a song selection tool and a customization wizard, as shown at step 2108. The user then selects the widget attributes and associated content, as shown at step 2110 and the client device then sends a request to the application server which identifies the selected attributes and contents that will be used with the widget selected by the user, as shown at step 2112. The application server stores the associated metadata and redirects the client device to a flash movie, as shown at step 2114. Afterwards, the client device generates a flash movie with the embedded options based on the attributes and the associated content selected by the user, as shown at step 2116. The widget in this example is a generated flash movie having the embedded options specified by the user at that time of selection of the widget's attributes and the associated content. After generation of the flash movie, the user can distribute a single song widget with the embedded options as shown at step 2118. The store builder resource component then prompts the user to confirm whether additional single song widgets are to be created, as shown at step 2120. If no more widgets are to be created, then the process ends, as shown at step 2122. If additional single song widgets are to be created, then the user is prompted to select additional widget attributes and associated content as shown at step 2110 and the process completes as discussed previously. Once the single song widget is created, a content owner can use it to promote an online store with the selected single song and associated metadata.

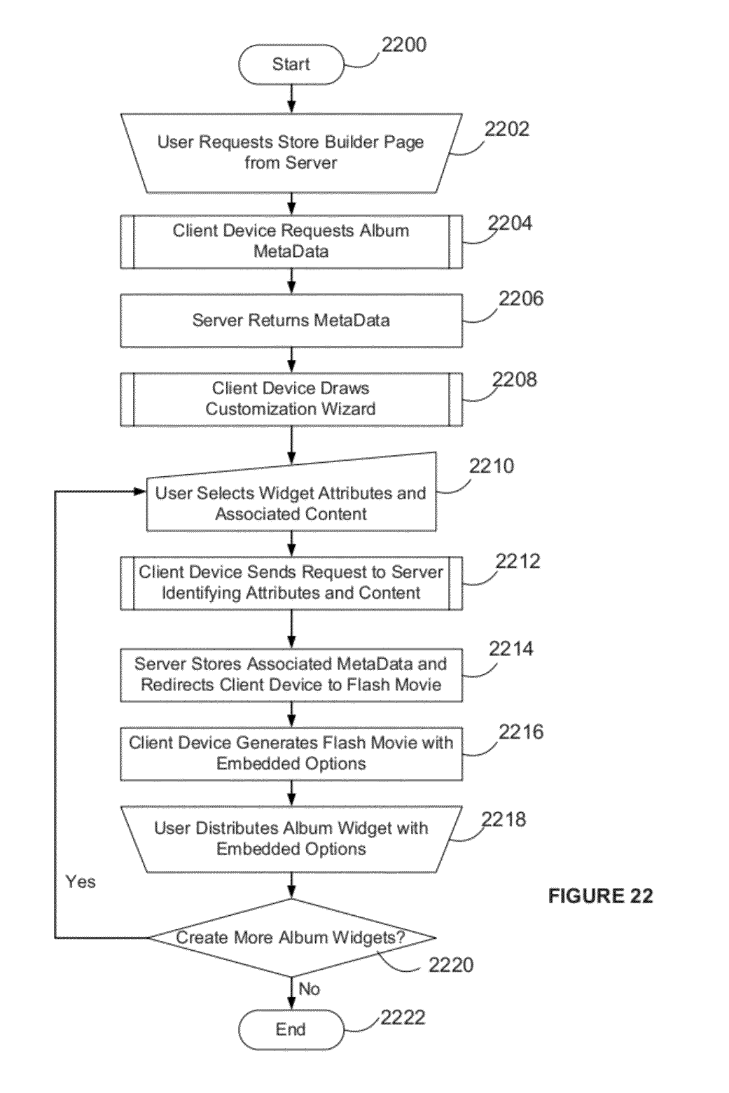

FIG. 22 is an illustration of a process in an embodiment for generating an album widget. This process commences at step 2200 with a user requesting a store builder page from the application server as shown at step 2202. Once the store builder page has been received, the user's client device requests the album metadata using a predefined process as shown at step 2204. The application server on which a content management system is hosted and executes returns the album metadata to the client device, as shown at step 2206, and the client device then draws a customization wizard in the browser of the client device, as shown at step 2208. Using this customization wizard, the user selects the widget's attributes and associated content, as shown at step 2210, and the client device then sends a request to the application server which identifies the attributes and contents to be associated with the widget selected by the user, as shown at step 2212. The application server stores the associated metadata and redirects the client device to a flash movie, as shown at step 2214, and the client device then generates a flash movie with the embedded options selected by the user, as shown at step 2216. Once generated, the user can then distribute the album widget over the Internet or over wireless communication networks to mobile devices. The widget that is distributed, however, will include the embedded options selected by the user, as shown at step 2218. The store builder resource component of a content management system executing on the application server then confirms whether the user wishes to create more album widgets, as shown at step 2220. If no additional widgets are to be created, then the process ends, as shown at step 2222. If additional album widgets are to be created, the user is again prompted to select widget attributes and associated content, as shown at step 2210, and the process continues as discussed previously.

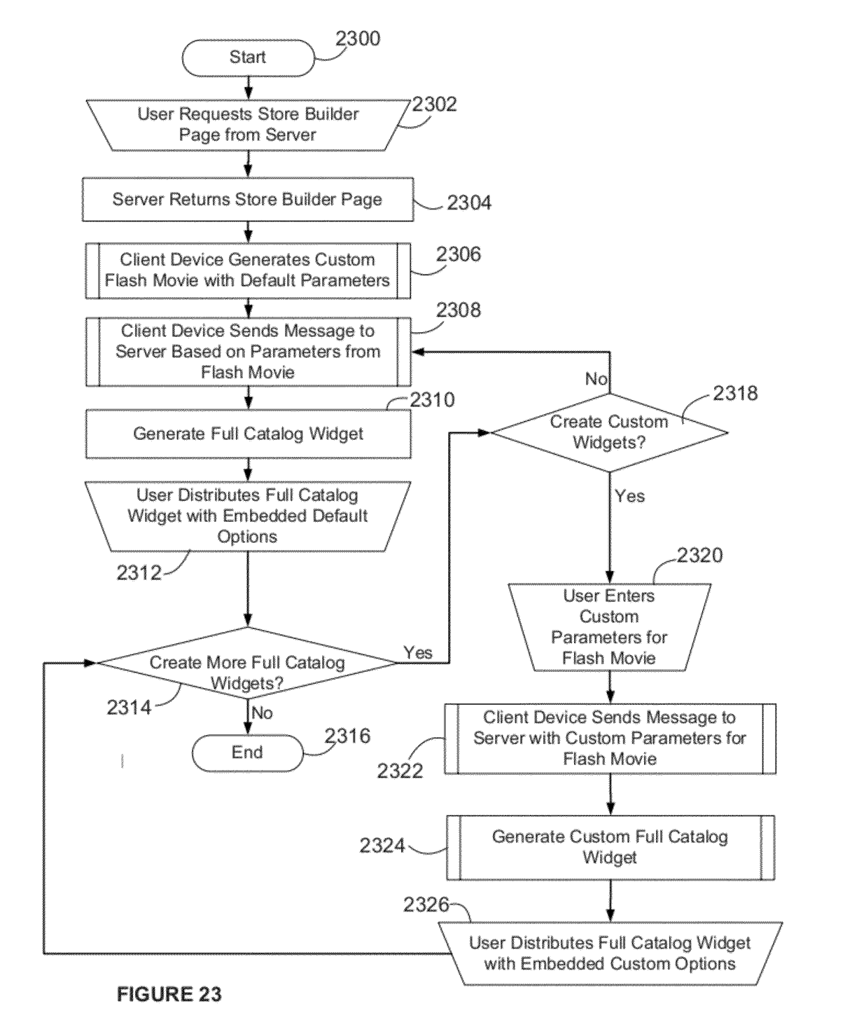

FIG. 23 illustrates a process for creating custom widgets for the promotion and marketing of full catalog content in an embodiment. This process commences at step 2300 with a user requesting a store builder page from a content management system hosted and executed on an application server, as shown at step 2302. The application server returns the store builder page to the client device, as shown at step 2304, and the client device then generates a custom flash movie with default parameters, as shown at 2306. This process was performed using a predefined process for generating flash movies provided by the content management system. The client device then sends a message to the application server which includes the default parameters from the flash movie, as shown at step 2308, to enable the generation of a full catalog widget, as shown at step 2310. Once generated, the full catalog widget with the embedded default options is made available for distribution by the user, as shown at step 2312. The store builder resource component then confirms whether additional full catalog widgets are to be created, as shown at step 2314. If no more widgets are to be created, then the process ends, as shown at step 2316. If additional full catalog widgets are to be created, then the store builder resource component will confirm whether the user wishes to create custom widgets, as shown at step 2318. If the user does not wish to create custom widgets, then the process resumes at step 2308 with the client device then sending a message to the application server which requests the creation of a full catalog widget with the default parameters in the flash movie. Alternatively, if a custom widget is to be created, then the user enters the custom parameters for the flash movie, as shown at step 2320, and the client device then sends a message to the application server requesting the generation of a flash movie with those custom parameters, as shown at step 2322. The application server then generates a custom full catalog widget, as shown at step 2324 and the user is then able to distribute the full catalog widget with the embedded custom options, as shown at step 2326. The user will again be prompted to confirm whether additional full catalog widgets are to be created and, if so, the process will resume with confirmation of whether the user wishes to create custom widgets as shown at step 2318. If no additional full catalog widgets are to be created, then the process will end, as shown at step 2316.

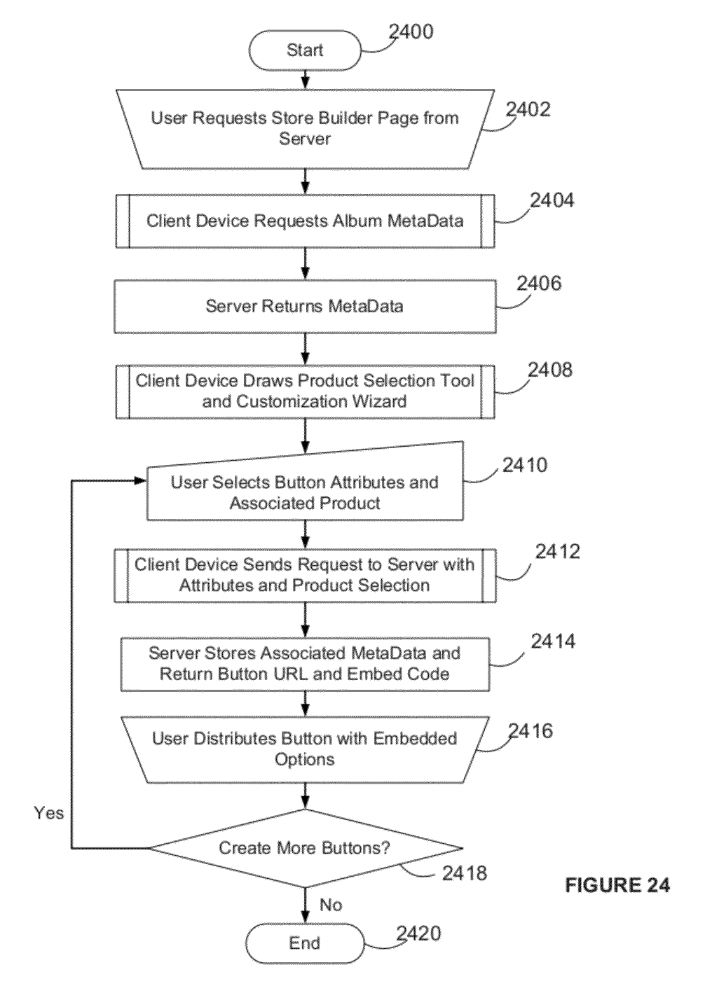

FIG. 24 is an illustration of a process in an embodiment for generating and distributing buy buttons for use and promotion of an online store. This process begins at step 2400 and involves the user requesting a store builder page from an application server, as shown at step 2402. In this embodiment, musical content will be associated with the creation of a buy button. However, other forms of multimedia content (e.g., videos, images, video games, etc.) can be used in association with the creation and distribution of buy buttons. The client device requests the album metadata that is associated with the music content to be promoted, as shown at step 2404 and the application server then returns the album metadata, as shown at step 2406. Based on the metadata, the client device then draws a product selection tool and a customization widget, as shown at step 2408. The user then selects button attributes and the associated product, as shown at step 2410, and the client device then sends a message request to the application server for the creation of a new buy button with the attributes and product selection, as shown at step 2412. The application server stores the metadata and returns to the client device a buy button Universal Resource Locator (or Button URL) and related embed code, as shown at step 2414. Once received, the user can then distribute the Button URL with its embedded options, as shown at step 2416. The store builder resource component then confirms with the user whether more buy buttons are to be created as shown at step 2418. If no additional buy buttons are to be created, then the process then ends as shown at step 2420. If additional buy buttons are to be created, then the process resumes at step 2410 with the user selecting button attributes and an associated product. The process then resumes as previously discussed after the user selects the button attributes and the associated product.

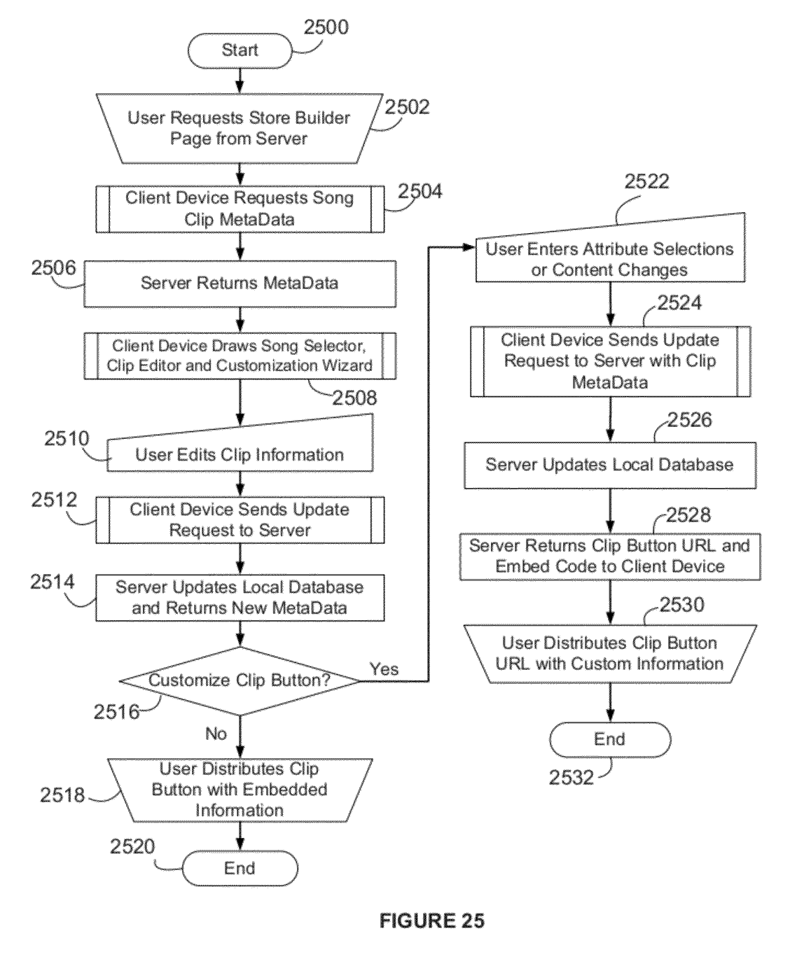

FIG. 25 illustrates a process in an embodiment for generating a preview clip that can be used to promote an online store. This process starts at step 2500 and commences with the user requesting a store builder page from an application server, as shown at step 2502. Once the store builder page is received from the application server, the user's client device then requests song clip metadata, as shown at step 2504, which data is returned in response this request by the application server, as shown at step 2506. Once received, the client device uses this metadata to draw a song selector, a clip editor and a customization wizard for display and execution in its browser, as shown at step 2508. The user edits the preview clip information, as shown at step 2510, and the client device then sends an update request to the application server, as shown at step 2512. The application server updates its local database and returns new metadata, as shown at step 2514, and then confirms whether the user wishes to customize the preview clip, as shown at step 2516. If the user does not wish to customize the preview clip, then the user can distribute a clip button with the embedded information, as shown at step 2518, and the clip creation process then ends, as shown at step 2520. Alternatively, if the user elects to customize the clip button, then the user must enter attribute selections or content changes, as shown at step 2522. Afterwards, the client device sends an update request to the application server with the clip metadata, as shown at step 2524, and the application server updates its local database based on the clip metadata, as shown at step 2526. In response to this request, the application server returns a clip button Universal Resource Locator (or Clip Button URL) and embed code to the client device, as shown at step 2528, and the user can then distribute the Clip Button URL with its custom information, as shown at step 2530, and the process then ends, as shown at step 2532.

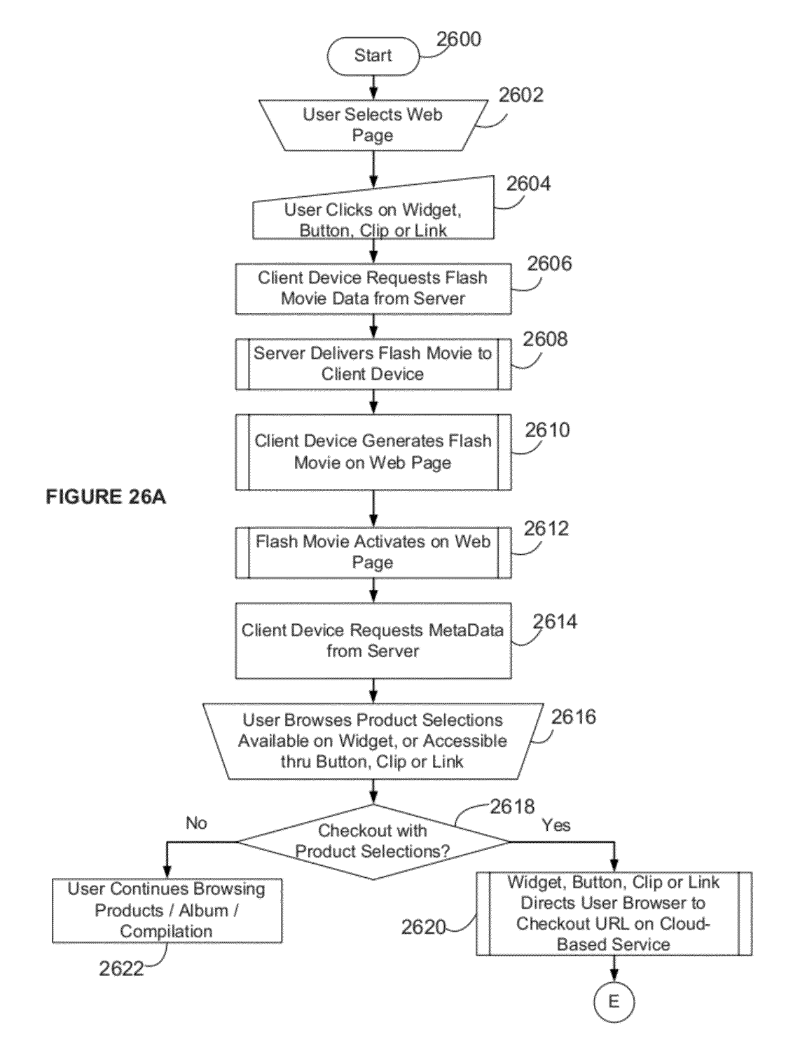

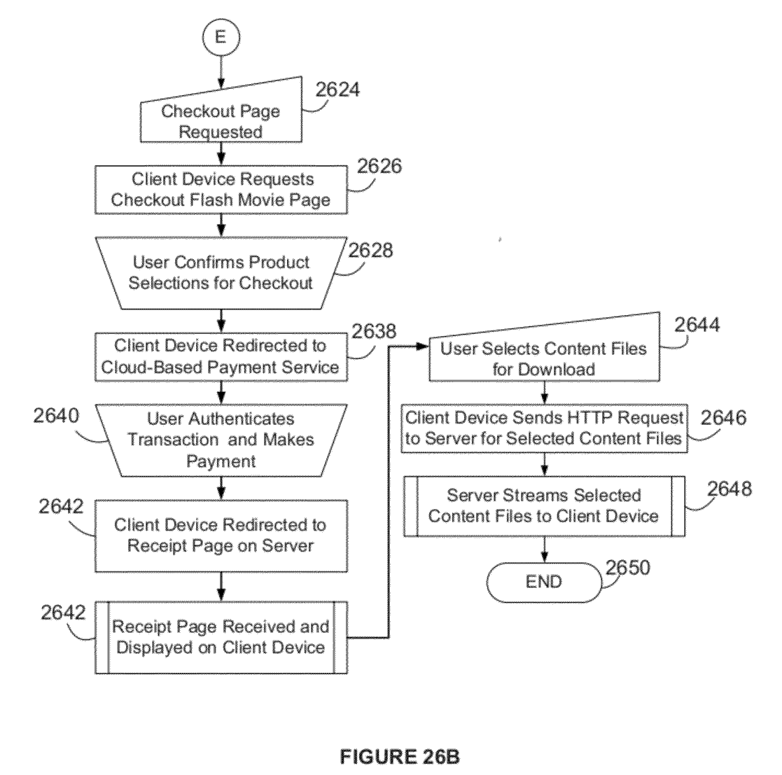

FIG. 26A illustrates a “checkout process” followed by a consumer when purchasing and downloading selected content from a content management system in an embodiment. The process starts at step 2600 and commences with a consumer using its client device to select a web page, as shown at step 2602. The user clicks on a widget, button, clip or link which has been distributed by a content owner, as shown at step 2604. Afterwards, the consumer's client device then requests a flash movie from the application server, as shown at step 2606. The application server which hosts and executes the content management system delivers the flash movie to the consumer's client device, as shown at step 2608. The consumer's client device then generates a flash movie on the web page selected by the consumer, as shown at step 2610. The flash movie activates on the web page using a pre-defined process, as shown at step 2612 and the client device then requests metadata associated with the flash movie from the application server, as shown at step 2614. The consumer browses the product selections available from the widget or accessible through the button, clip or link, which was on the web page selected by the consumer, as shown at step 2616. After selections are completed, the content management system then confirms whether the consumer wishes to complete the checkout process with the specified products, as shown at step 2618. If the user does not wish to checkout with the specified products, then the consumer will continue browsing the products, the album, or the compilation associated with the widget, button, clip or link that was selected initially, as shown at step 2622. If the consumer is ready to checkout with product selections, then the widget, button, clip or link used by the consumer will direct the consumer's browser to a checkout Universal Resource Locator or (Checkout URL) on a cloud-based service, as shown at step 2620.

Continuing onto FIG. 26B, the consumer requests the checkout page, as shown at step 2624 and the consumer's client device then sends a request for a checkout flash movie page, as shown at step 2626. Once this page is received and displayed on the consumer's client device, the consumer confirms product selections for the checkout process, as shown at step 2628, and the consumer's client device then redirects the consumer to a cloud-based payment service, as shown at step 2638. In one embodiment the cloud-based payment service is the Amazon FPS. The consumer authenticates the transaction and makes a payment using the payment service, as shown at step 2640, and then the consumer's client device redirects to a receipt page which is delivered by the application server, as shown at step 2642. After the receipt page is received and displayed on the consumer's client device, the user then manually selects content files for downloading, as shown at step 2644. In one embodiment, the client device then sends a hypertext transfer protocol (HTTP) request to the application server that requests the downloading of the selected content file, as shown at step 2646. Upon receiving this message, the application server streams the selected content file or files to the consumer's client device, as shown at step 2648. The consumer checkout process then completes as shown at step 2650.

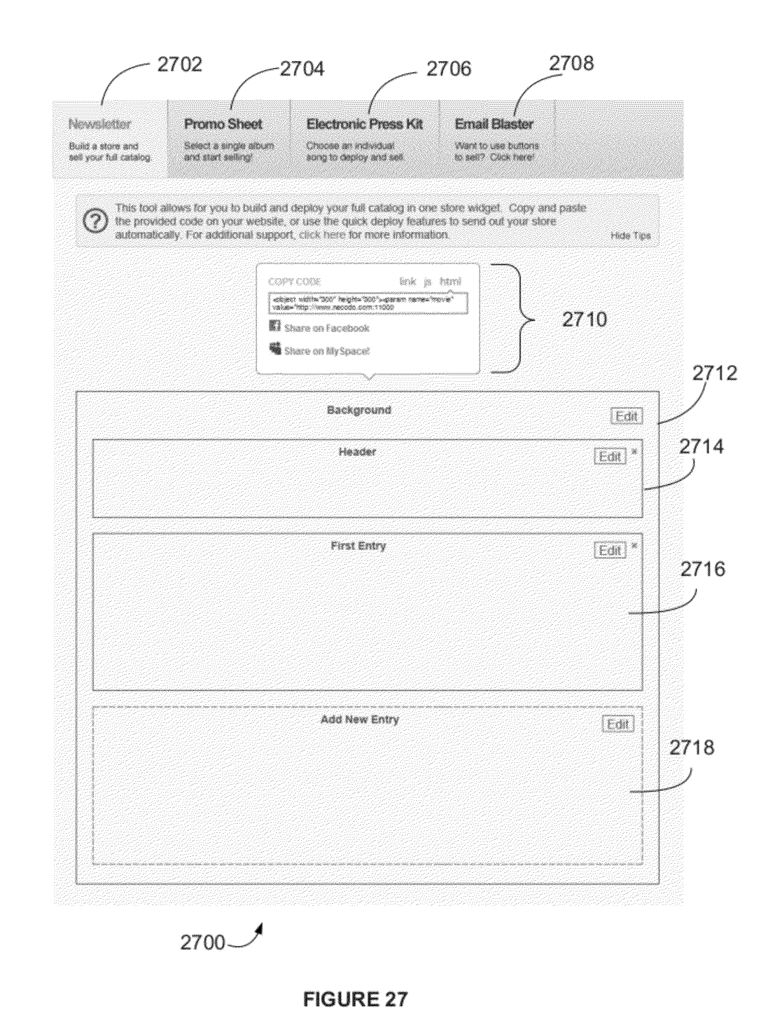

FIG. 27 is a display diagram illustrating an embodiment of a user interface for a marketing resource component in a content management system. User interface 2700 includes several components for use by content owners, including a newsletter module 2702, a promotion sheet module 2704, an electronic press kit module 2706 and an e-mail blaster module 2708. In addition, the marketing resource component includes Copy Code that can be shared on one or more social networking or social bookmarking websites, as illustrated in panel 2710. As displayed, the user has selected the newsletter module to create a new newsletter to promote certain content. The user interface 2700 includes several fields for the creation of a newsletter in this embodiment, which fields identify a Background section 2712, a Header section 2714, a First Entry section 2716 and an Add-New Entry section 2718 for the newsletter. By using these fields, a content owner can create a custom newsletter for distribution to subscribers or other marketing partners that may also include information to promote one or more of a content owner's online stores. The Background section 2712 can be used to set the theme or tone of a newsletter with alternative color schemes or designs. The Header section 2714 allows a content owner to include text which, in an embodiment, generally describes the theme or tone for a compilation release or song that is the subject of the newsletter. The First Entry section 2716 can be used by a content owner to identify the compilation release or song that is being promoted in the newsletter. Likewise, section 2718 allows additional entries to be added for discussion or promotion in the newsletter.

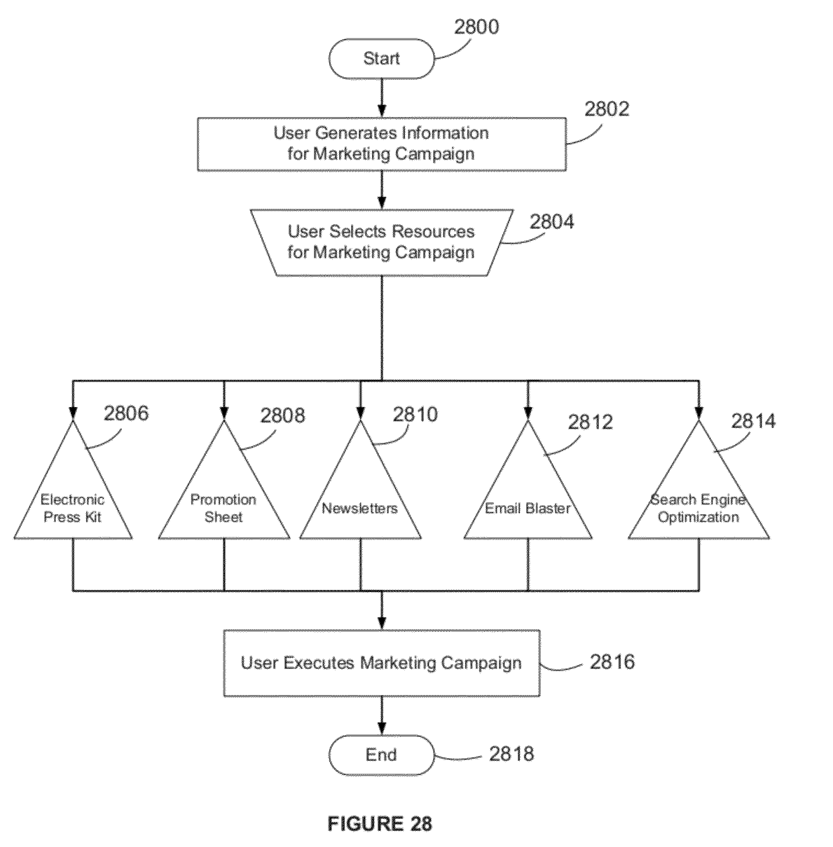

FIG. 28 illustrates a process for generating marketing information using the marketing resource component of a content management system in one embodiment. This process starts at step 2800 and commences with a user generating information for a marketing campaign, as shown at step 2802. This information can be textual information, audio information, audio-visual information or descriptive references to physical goods or other types of goods, products or related services. The content owner then selects from among various resources in the content management system for the creation of a marketing campaign, as shown at step 2804. Among the resources available to a content owner are an electronic press kit 2806, a promotion sheet 2808, one or more newsletters 2810, an e-mail blaster 2812 and a search engine optimization feature 2814. The search engine optimization feature 2814 allows a content owner to create search engine optimized web pages on which online stores can be deployed. In selecting from the various resources in the marketing resource component, a content owner is not limited to selecting only one form of marketing material or resource but may choose to use a combination of one or more resources to maximize the effect of their marketing message. After selection of the appropriate resources, the user executes a new marketing campaign, as shown at step 2816. Upon launch of the market campaign, the process for generating marketing information ends, as shown at step 2818. At any time before, during, or after the execution of a marketing campaign, a content owner may elect to create new information and to use additional marketing resources to enhance existing marketing campaigns or to initiate new marketing campaigns.

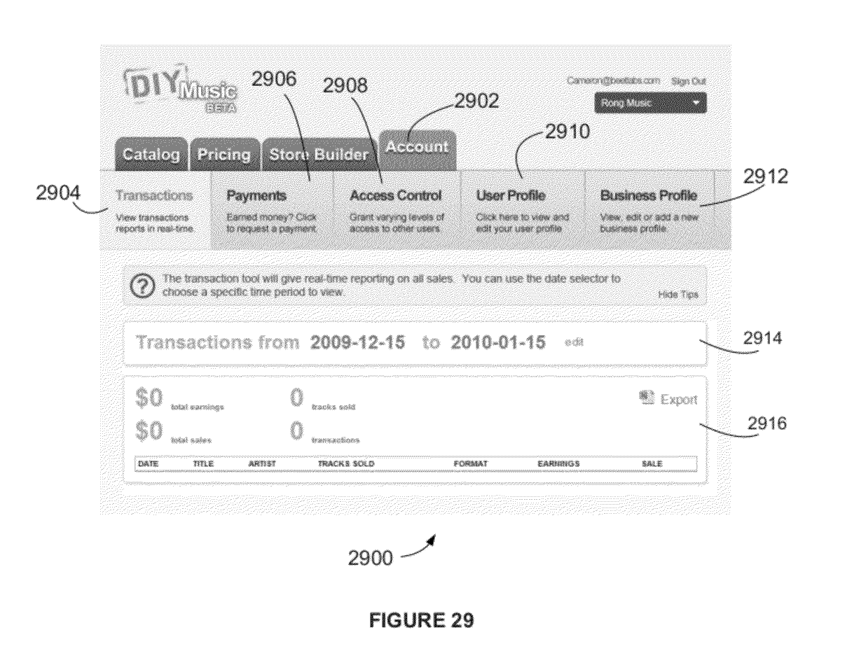

FIG. 29 illustrates a display diagram of a user interface for the accounts tracking component in a content management system in one embodiment. User interface 2900 includes several components for use by content owners. The accounts tracking component is selected by clicking on tab 2902 in the content management system. Upon clicking this tab, several resources are then made available to a content owner. Among the resources provided in this component are a transactions logging resource 2904, a payments tracking resource 2906, an access control resource 2908, a user profile section 2910, and a business profile section 2912. This component also enables content owners to search and analyze transactions over discreet periods of time, as is illustrated in field 2914. In this example, the content owner is reviewing transactions over a period commencing on Dec. 15, 2009 and ending on Jan. 15, 2010. This user interface 2900 also enables a content owner to track total earnings, total sales and other relevant metrics or transactions in a separate field 2916 as shown in this embodiment. The access control section 2908 allows a content owner to set access restrictions on a per-content file basis, a per-release basis, or a per-compilation basis as desired to limit or control the scope of access provided to third party agents and representatives. The user profile 2910 is used to establish and store a profile in the content management system that will allow that system to identify the content owner within the system and all content associated with the content owner. The business profile 2912 allows a content owner to create multiple accounts that can be accessed using one login. In an embodiment, the business profile 2912 is used to provide a content owner with the ability to create several business operations, or labels in the case of a music franchise, which can be used to promote or market unique compilations, releases or specific collections of content files whether they be individual songs or physical goods created by the content owner.

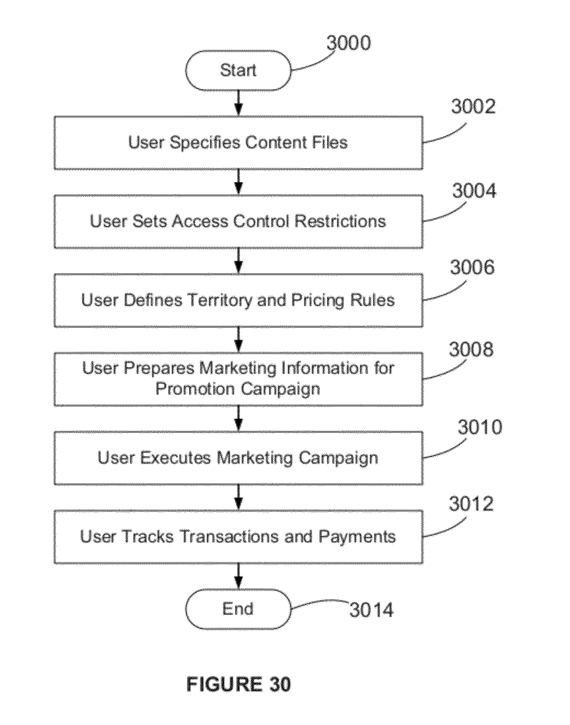

FIG. 30 depicts a process for using the accounts tracking component in a content management system. This process starts at step 3000 and involves a user specifying specific content files, as shown at step 3002. Once specified, a user can set one or more access control restrictions, as shown at step 3004 and also set territorial restrictions and pricing rules for different geographic markets, as shown at step 3006. The content owner can prepare marketing information for a promotional campaign, as shown at step 3008, and then execute the campaign, as shown at step 3010. The results of the marketing campaign based on the content owner's marketing information and applicable territorial and pricing restrictions can then be tracked using the accounts tracking component, as shown at step 3012. Both transactions and payments are registered in this component and are made available for review and analysis by a content owner. Upon completion of a marketing campaign, this process then ends, as shown at step 3014.

Although specific embodiments have been illustrated and described herein, it will be appreciated by those of ordinary skill in the art that a wide variety of alternate and/or equivalent implementations may be substituted for the specific embodiments shown and described without departing from the scope of the present invention. This application is intended to cover any adaptations or variations of the embodiments discussed herein.

What is claimed is:

1. A system for content management having a processor and a memory, the processor and the memory configured to execute software instructions for implementing the system, the system comprising:
a content management component operative to upload multimedia content and to create at least one compilation from the multimedia content;
a market management component operative to assign market-specific data to the at least one compilation; and
a store builder resource component operative to generate at least one online store for promotion of the at least one compilation having the assigned market-specific data.

2. The system of claim 1 wherein the content management component is further operative to register the uploaded multimedia content in the memory.

3. The system of claim 1 wherein the multimedia content includes a plurality of digital media files, each of the digital media files having a first format.

4. The system of claim 3 wherein the content management component is further operative to register the uploaded multimedia content in the memory after the first format of each of the digital media files is converted to a second format.

5. The system of claim 4 wherein the digital media files are digital music content files, the first format is a WAV format and the second format is an MP3 format.

6. The system of claim 1 further comprising:
a marketing resource component operative to generate marketing resources for promotion of the at least one compilation; and
an accounts tracking component operative to provide at least one access control for limiting third party access to the at least one compilation, the content management component, the market management component, the store builder resource management component and a marketing resource component.

7. The system of claim 4 wherein the multimedia content is uploaded to a data storage resource on a cloud-based computing and storage network, the processor communicatively coupled to the cloud-based computing and storage network.

8. The system of claim 1 wherein the multimedia content includes at least one of a digital audio file, a digital video file, an e-book file, a digital audio-book file, a computer-based video game file, a digital image file and a digital file including a representation of one or more physical goods.

9. The system of claim 7 wherein the content management component is operative to upload the multimedia content from at least one of a first group of client devices to the cloud-based computing and storage network.

10. The system of claim 1 wherein the content management component is operative to upload the multimedia content using an image uploader when the multimedia content is comprised of at least one digital image file.

11. The system of claim 1 wherein the content management component is operative to upload the multimedia content using an audio uploader when the multimedia content is comprised of at least one digital audio file.

12. The system of claim 1 wherein the market-specific data is at least one of a market selling price for one or more content files provided as the multimedia content and a geographic territory for promotion of the one or more content files.

13. The system of claim 1 wherein the compilation is a single digital media file.

14. The system of claim 13 wherein the compilation further includes a plurality of metadata related to the single digital media file.

15. The system of claim 1 wherein the promotion of the at least one generated online store is performed using at least one of a widget, a buy button, an HTTP link and a preview video clip.

16. The system of claim 15 wherein the multimedia content included in the at least one generated online store is determined in part from embedded parameters used to create the at least one widget, buy button, HTTP link and preview video clip used for promotion of the generated online store.

17. The system of claim 1 wherein the promotion of the at least one generated online store is performed using at least one of a full-catalog store widget, a single release store widget and a single song store widget.

18. The system of claim 1 wherein the promotion of the at least one online store is performed from distributing at least one of a widget, a buy button, an HTTP link and a preview video clip over a network, the network being at least one of the Internet and a mobile device communications network.

19. The system of claim 9 further comprising a second group of client devices, each of the second group of client devices operative to receive the at least one compilation, the first group of client devices and the second group of client devices including at least one of a desktop computer, a laptop computer, a personal digital assistant (PDA), a smart phone, a cell phone, a portable media player, a handheld game console, a digital camera and an e-book reader.

20. The system of claim 1 wherein the content management component is further operative to:
request a content distribution feed from a content distributor, the content distribution feed including a plurality of digital content files and a plurality of metadata related to each of the plurality of digital content files, and
include the plurality of digital content files and the plurality of related metadata in the at least one compilation created from the multimedia content.

21. The system of claim 1 wherein the at least one compilation includes a plurality of digital media files and metadata related to each of the plurality of digital media files.

22. The system of claim 21 wherein the digital media files are digital music content files including digital music content and the metadata is related to the digital music content in each of the digital music content files, each of the digital music content files having a file format of at least one of an MP3 format and a WAV format.

23. The system of claim 22 wherein the metadata includes at least one of a title name, an artist name, a release date, a genre, a catalog number and a universal product code.
